(19) United States
(12) Patent Application Publication
(10) Pub. No.: US 2025/0057182 A1
(43) Pub. Date: Feb. 20, 2025

(54) DIETARY EARLY GLYCATION PRODUCTS FOR TREATING AND PREVENTING AUTOIMMUNE DISEASES

(71) Applicant: University of Georgia Research Foundation, Inc., Athens, GA (US)

(72) Inventors: Tai L. Guo, Bogart, GA (US); Yingjia Chen, Bogart, GA (US)

(21) Appl. No.: 18/935,724

(22) Filed: Nov. 4, 2024

Related U.S. Application Data
(62) Division of application No. 17/420,411, filed on Jul. 2, 2021.
(60) Provisional application No. 62/792,650, filed on Jan. 15, 2019.

(51) Int. Cl. A23J 3/08; A23J 1/20

(52) U.S. Cl. CPC A23J 3/08; A23J 1/20

(57) ABSTRACT

Therefore, disclosed herein is a composition comprising dietary early glycation products (EGPs) with less than 1 wt % advanced glycation end products (AGEs). Also disclosed is a method for treating or preventing diabetes in a subject, such as type 1 diabetes, type 2 diabetes, or gestational diabetes, that involves administering to a subject in need thereof a composition disclosed herein.

### CROSS-REFERENCE TO RELATED APPLICATIONS

This application is a divisional application of U.S. Nonprovisional application Ser. No. 17/420,411, filed Jul. 2, 2021, which is a US national stage application of International Application No. PCT/US2020/013595, filed Jan. 15, 2020, which claims benefit of U.S. Provisional Application No. 62/792,650, filed Jan. 15, 2019, which are hereby incorporated herein by reference in their entireties.

### STATEMENT REGARDING FEDERALLY SPONSORED RESEARCH OR DEVELOPMENT

This invention was made with Government Support under Grant Nos. ES024487 and AT009523 awarded by the National Institutes of Health, and under Grant No. 2016-67021-24994 awarded by the United States Department of Agriculture. The Government has certain rights in the invention.

### BACKGROUND

Type 1 diabetes (T1D) is a disease due to autoimmune destruction of insulin-producing pancreatic β-cells. There is no known preventive measure for type 1 diabetes. Medications used to treat diabetes do so by lowering blood sugar levels. Needed in the art are nutraceuticals or medical foods that can treat or prevent T1D.

### SUMMARY

In the non-obese diabetic (NOD) mouse, one of the murine models for human T1D, innate immune cells (e.g., dendritic cells, macrophages, neutrophils) infiltrate the pancreas as early as 3 weeks of age, and then attract CD4⁺ and CD8⁺ T cells into the pancreas at 4-6 weeks of age [Pearson JA, et al. J Autoimmun, 2016 66:76-88] to abruptly initiate insulitis (intra-islet inflammatory infiltrate). The mechanisms of T cell induced β-cell death include: 1) direct cell-cell contact through recognition of MHC class I molecules by CD8⁺ T cells; 2) killing β-cells through surface receptor or secreted cytokines/chemokines by recognizing β-cell antigen presented by antigen-presenting cells (APCs; e.g., B cells, macrophages) [Mathis D, et al. Nature, 2001 414:792-8]. T cells further recruit other immune cells to directly kill β-cells or facilitate the function of T cells. Other important pancreatic infiltrates are B cells and macrophages. B cell plays as APCs and costimulators for T cells, and boost the production of autoantibodies [Pearson JA, et al. J Autoimmun, 2016 66:76-88]. Macrophage is a vital APC and cytokine/chemokine-secreting cell.

Anti-inflammatory agents have the potential for T1D prevention. For example, the anti-inflammatory protein, alpha1-antitypsin (AAT), prevented T1D in NOD mice [Song S, et al. Gene Ther, 2004 11:181-6] and reduced % HbA1c and pancreatic autoantibodies in newly diagnosed T1D children/adolescents [Rachmiel M, et al. Pediatr Diabetes, 2016 17:351-9]. Anti-inflammatory components from diet, such as polyherbal supplementation that decreased NF-κB activity and chemotaxis chemokines (i.e., CCL2 and CXCL10) in 832/13 rat insulinoma cells, could stabilize blood glucose level (BGL) and prevent T1D in NOD mice with decreased CD3⁺ infiltrates in the pancreas [Burke SJ, et al. Nutr Res, 2015 35:328-36].

As disclosed herein, dietary early glycation products (EGPs) can regulate the inflammatory process when applied to human macrophages (PMA-differentiated-U937 cells) [Chen Y, et al. Mol Nutr Food Res, 2018 62:e1700641]. Also as disclosed herein, EGPs can protect against T1D through the regulation of immune responses. EGPs were shown to delay the T1D onset and reduced the T1D incidence in the autoimmune prone NOD mice. However, minimal effects were observed in the multiple low dose (MLD) streptozotocin (STZ)-induced hyperglycemia in C57BL/6 females, in which chemical destruction of pancreatic β-cells was the major mechanism. Because these EGPs are produced from food-grade raw materials involving only well-controlled heating, they are still considered food. Therefore, the beneficial effect observed on T1D prevention would highly qualify EGPs as nutraceuticals or medical food for patients with insulitis and T1D. Also as disclosed herein, EGPs can also protect against autoimmune prostatitis and other organ-specific autoimmune diseases.

Therefore, disclosed herein is a composition comprising glycated α-lactalbumin and glycated β-lactoglobulin. In some embodiments, each α-lactalbumin has 0 to 12 glucose moieties, 0 to 6 glucose moieties, 7 to 12 glucose moieties, or 3 to 8 glucose moieties, including 0, 1, 2, 3, 4, 5, 6, 7, 8, 9, 10, 11, or 12 glucose moieties. In some embodiments, each β-lactoglobulin has 0 to 16 glucose moieties, 0 to 8 glucose moieties, 9 to 12 glucose molecules, or 3 to 12 glucose molecules, including 0, 1, 2, 3, 4, 5, 6, 7, 8, 9, 10, 11, 12, 13, 14, 15, or 16 glucose moieties. In some embodiments, the combined α-lactalbumin and β-lactoglobulin has 1 to 28 glucose moieties, 1 to 14 glucose moieties, 15 to 28 glucose moieties, or 6 to 12 glucose moieties, including 0, 1, 2, 3, 4, 5, 6, 7, 8, 9, 10, 11, 12, 13, 14, 15, 16, 17, 18, 19, 20, 21, 22, 23, 24, 25, 26, 27, or 28 glucose moieties.

In some embodiments, the composition comprises non-detectable levels of nonglycated α-lactalbumin or β-lactoglobulin. In addition, the composition preferably comprises less than 1 wt % advanced glycation end products (AGEs), including less than 0.1, 0.2, 0.3, 0.4, 0.5, 0.6, 0.7, 0.8, 0.9, or 1.0 wt % AGEs.

In some embodiments, the glycated β-lactoglobulin comprises glycated β-lactoglobulin A, glycated β-lactoglobulin B, or a combination thereof.

In some embodiments, the composition comprises at least 95 wt % glycated α-lactalbumin and glycated β-lactoglobulin.

In some embodiments, at least 74% of the α-lactalbumin have 6 glucose moieties. In some embodiments, at least 54% of the β-lactoglobulin has 10 glucose moieties.

In some cases, the disclosed composition is produced by a process comprising dissolving a protein isolate capable of forming glycation products and glucose in water, freeze-drying the solution to produce a powder, and incubating the powder in heated dry air for 1 to 12 hours.

In preferred embodiments, the protein isolate is a whey protein isolate (WPI); however, other protein isolates capable of forming glycation products are known and can be used in the disclosed compositions and methods.

A preferred ratio of protein isolate (e.g. WPI) to glucose can be determined empirically. In some embodiments, the molar ratio of free amino groups and reducing ends is about 1:2.

In some embodiments, the powder is incubated at a water activity of 0.4-0.6 aw, where the highest glycation speed is achieved

In some embodiments, the powder is incubated at a temperature of 30° C. to denaturation temperature, which can be determined in silico.

In some embodiments, the composition further comprise a nutraceutically acceptable excipient.

Also disclosed is a method for treating or preventing an autoimmune disease in a subject that involves administering to a subject in need thereof a composition disclosed herein. Autoimmune disease refers to illness or disorder that occurs when healthy tissue (cells) get destroyed by the body's own immune system. In the case of type 1 diabetes, the disease-fighting system mistakes healthy cells in the pancreas for foreign, harmful invaders and attacks them, leaving the body unable to produce its own insulin and keep levels of blood glucose under control. There are more than 80 different types of autoimmune disease, including Achalasia, Addison's disease, Adult Still's disease, Agammaglobulinemia, Alopecia areata, Amyloidosis, Ankylosing spondylitis, Anti-GBM/Anti-TBM nephritis, Antiphospholipid syndrome, Autoimmune angioedema, Autoimmune dysautonomia, Autoimmune encephalomyelitis, Autoimmune hepatitis, Autoimmune inner ear disease (AIED), Autoimmune myocarditis, Autoimmune oophoritis, Autoimmune orchitis, Autoimmune pancreatitis, Autoimmune retinopathy, Autoimmune urticaria, Axonal & neuronal neuropathy (AMAN), Baló disease, Behcet's disease, Benign mucosal pemphigoid, Bullous pemphigoid, Castleman disease (CD), Celiac disease, Chagas disease, Chronic inflammatory demyelinating polyneuropathy (CIDP), Chronic recurrent multifocal osteomyelitis (CRMO), Churg-Strauss Syndrome (CSS) or Eosinophilic Granulomatosis (EGPA), Cicatricial pemphigoid, Cogan's syndrome, Cold agglutinin disease, Congenital heart block, Coxsackie myocarditis, CREST syndrome, Crohn's disease, Dermatitis herpetiformis, Dermatomyositis, Devic's disease (neuromyelitis optica), Discoid lupus, Dressler's syndrome, Endometriosis, Eosinophilic esophagitis (EoE), Eosinophilic fasciitis, Erythema nodosum, Essential mixed cryoglobulinemia, Evans syndrome, Fibromyalgia, Fibrosing alveolitis, Giant cell arteritis (temporal arteritis), Giant cell myocarditis, Glomerulonephritis, Goodpasture's syndrome, Granulomatosis with Polyangiitis, Graves' disease, Guillain-Barre syndrome, Hashimoto's thyroiditis, Hemolytic anemia, Henoch-Schonlein purpura (HSP), Herpes gestationis or pemphigoid gestationis (PG), Hidradenitis Suppurativa (HS) (Acne Inversa), Hypogammalglobulinemia, IgA Nephropathy, IgG4-related sclerosing disease, Immune thrombocytopenia purpura (ITP), Inclusion body myositis (IBM), Interstitial cystitis (IC), Juvenile arthritis, Juvenile diabetes (Type 1 diabetes), Juvenile myositis (JM), Kawasaki disease, Lambert-Eaton syndrome, Leukocytoclastic vasculitis, Lichen planus, Lichen sclerosus, Ligneous conjunctivitis, Linear IgA disease (LAD), Lupus, Lyme disease chronic, Meniere's disease, Microscopic polyangiitis (MPA), Mixed connective tissue disease (MCTD), Mooren's ulcer, Mucha-Habermann disease, Multifocal Motor Neuropathy (MMN) or MMNCB, Multiple sclerosis, Myasthenia gravis, Myositis, Narcolepsy, Neonatal Lupus, Neuromyelitis optica, Neutropenia, Ocular cicatricial pemphigoid, Optic neuritis, Palindromic rheumatism (PR), PANDAS, Paraneoplastic cerebellar degeneration (PCD), Paroxysmal nocturnal hemoglobinuria (PNH), Parry Romberg syndrome, Pars planitis (peripheral uveitis), Parsonage-Turner syndrome, Pemphigus, Peripheral neuropathy, Perivenous encephalomyelitis, Pernicious anemia (PA), POEMS syndrome, Polyarteritis nodosa, Polyglandular syndromes type I, II, III, Polymyalgia rheumatica, Polymyositis, Postmyocardial infarction syndrome, Postpericardiotomy syndrome, Primary biliary cirrhosis, Primary sclerosing cholangitis, Progesterone dermatitis, Psoriasis, Psoriatic arthritis, Pure red cell aplasia (PRCA), Pyoderma gangrenosum, Raynaud's phenomenon, Reactive Arthritis, Reflex sympathetic dystrophy, Relapsing polychondritis, Restless legs syndrome (RLS), Retroperitoneal fibrosis, Rheumatic fever, Rheumatoid arthritis, Sarcoidosis, Schmidt syndrome, Scleritis, Scleroderma, Sjogren's syndrome, Sperm & testicular autoimmunity, Stiff person syndrome (SPS), Subacute bacterial endocarditis (SBE), Susac's syndrome, Sympathetic ophthalmia (SO), Takayasu's arteritis, Temporal arteritis/Giant cell arteritis, Thrombocytopenia purpura (TTP), Tolosa-Hunt syndrome (THS), Transverse myelitis, Type 1 diabetes, Ulcerative colitis (UC), Undifferentiated connective tissue disease (UCTD), Uveitis, Vasculitis, Vitiligo, and Vogt-Koyanagi-Harada Disease.

In some embodiments, the autoimmune disease comprises diabetes, such as type 1 diabetes, type 2 diabetes, or gestational diabetes, In some embodiments, the method delays the onset of diabetes in the subject. In some embodiments, the method reduces the incidence of diabetes in the subject. In some embodiments, the autoimmune disease comprises autoimmune prostatitis.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A and 1B show early glycation product (EGP) preparation and identification. FIG. 1A is a scheme for EGP preparation. Whey protein isolate (WPI) and glucose were dissolved in Milli-Q water and the solution was freeze-dried. The resulted powders were incubated in a sealed desiccator maintained at aw 0.53 and 55° C. Samples were removed at different time points to quantitate the glycation markers for different glycation stages. The 8 h samples were determined as EGPs, with 0 and 240 h samples as non-reacted (NR) samples and advanced glycation end product (AGE) controls, respectively. FIG. 1B shows deconvoluted mass spectra (mass displayed: 14,000-21,500 Da) for NR and EGPs. NR samples were basically the same as WPI (FIG. 10). In the EGP samples, all proteins were glycated: α-lactalbumin had 3-11 glucoses attached; β-lactolbumin had 5-15 glucoses attached.

FIGS. 2A to 2G show EGPs have minimal effects on MLD-STZ-induced hyperglycemia. The hyperglycemia in C57BL/6 females were induced by STZ injection (50 mg/kg BW/day, i.p., 4 doses). FIG. 2A to 2D show BW (FIG. 2A), food consumption (FIG. 2B), water consumption (FIG. 2C), and non-fasting BGL (FIG. 2D) measured weekly or biweekly. FIG. 2E shows GTT and ITT measured at week 5 post STZ injection. Significance detected during ITT was shown in the table (food and water consumption were measured by cage; the other results were presented as mean±SE, n=5-6). FIG. 2F shows the histopathological changes of β-islets from each animal were evaluated from aspects of inflammation and vacuolation by scoring from 0 to 3. FIG. 2G shows representative images of β-islets of detected scores. Arrows in the upper panels indicate inflammatory cells, and those in the lower panels indicate vacuoles. a, b,P<0.05.

FIGS. 3A to 3G show EGPs delay T1D onset in NOD females. NOD females (6-8 weeks old) were orally gavaged with water, NR or EGPs for 4 weeks. FIGS. 3A and 3B show BW (FIG. 3A) and non-fasting BGL (FIG. 3B) monitored weekly. The BGL change in the non-diabetic mice is summarized and graphed, the arrow indicates T1D incidence in water and NR groups. FIG. 3C shows GTT and ITT conducted at the end of week 4 (mean±SE, n=7-8, the data was combined of two independent repeats). Another set of age matched NOD females were dosed with NR or EGPs. FIG. 3D shows the non-fasting BGL change of the non-diabetic mice. FIG. 3E shows GTT and ITT conducted after dosing for 8 weeks (mean±SE, n=7-11). FIG. 3F shows a record of the diabetes incidence (diabetic: BGL>200 mg/dl, nNR=11, nEGPs=10). FIG. 3G shows pancreases of non-diabetic NOD females (being treated for 4 weeks) harvested, and the number of immune cells (i.e., total immune infiltrates, macrophages, CD8+ T cells, CD4+ T cells, B cells) within pancreas dissociated and analyzed by flow cytometry (mean±SE, n=3-4). +, P<0.05, ++, P<0.01 EGPs vs water; *, P<0.05, **, P<0.01 EGPs vs NR.

FIGS. 4A to 4E show EGPs have protective effects on NOD males. Age matched diabetic free NOD males (>16 weeks old) were dosed with NR or EGPs for 24 weeks. FIGS. 4A to 4C show BW (FIG. 4A), moribund incidence (FIG. 4B), and non-fasting BGLs (FIG. 4C) recorded. FIG. 4D shows GTT and ITT performed at week 12 and 24 (mean±SE, n=11-15 for week 12, n=6 for week 24). FIG. 4E shows after 24 weeks of treatment, the immune cells (i.e., total immune infiltrates, macrophages, CD8⁺ T cells, CD4⁺ T cells, B cells) within pancreas were dissociated and studied using flow cytometry (mean±SE, n=6). *, P<0.05, *, P<0.01.

FIGS. 5A and 5B show EGPs decrease CD8⁺ T cells, and increase splenic M2/M1 ratio and CD25⁺ regulatory T cells. NOD females (6-8 weeks old) were orally gavaged with water, NR or EGPs for 4 weeks. FIG. 5A shows CD4/CD8 and CD44CD25 thymocyte analysis by flow cytometry. FIG. 5B shows analysis of splenic leukocytes, macrophages (M2 (F4/80⁺CD209⁺CD80⁻), M1 (F4/80⁺CD2090⁻CD80⁺) and M2/M1 ratio), CD4⁺ T cells (CD3⁺CD4⁺CD80⁻), CD25⁺ regulatory T cells (CD3⁺CD4⁺CD80⁻CD25⁺), CD8⁺ T cells (CD3+CD40⁻CD8⁺), B cells (B220⁺) and CD40L⁺ B cells (B220⁺CD40L⁺) analyzed by flow cytometry (mean±SE, n=7-8). +, P<0.05, ++, P<0.01 EGPs vs water; *, P<0.05, **, P <0.01 EGPs vs NR.

FIG. 6 shows EGPs increase serum IL-10. The serum cytokines/chemokines from NOD females were quantitated, and the key regulators for T1D were graphed (mean±SE, n=7-8). The scale indicates the fold change. IL-10 was increased 86-and 3-folds by EGPs when compared to water and NR, respectively.

FIGS. 7A and 7B show EGPs decrease IgG1 and IAAs. FIG. 7A shows the Ig isotypes (i.e., IgM, IgG1, IgG2b, IgG2c) in the sera from NOD females detected by ELISA (mean±SE, n=7-8). FIG. 7B shows measurement of anti-insulin IgM and IgG. To determine the specificity of IAAs, sera at the dilution of 1:5 were incubated with 10-fold excess of insulin (right column of both panels, mean±SE, n=4). +, P<0.05, ++, P<0.01 EGPs vs water; *, P<0.05, **, P<0.01 EGPs vs NR.

FIG. 8 shows CML quantitation in rodent chow. CML amount was quantitated using OxiSelect CML competitive ELISA kit (Cell Biolabs, San Diego, CA, USA) following the manufacturer's instructions: The levels of 323 ng CML/g in diet 5053 and 235 ng CML/g in diet 5058 were identified.

FIGS. 9A and 9B show gating strategies for T cells, macrophages and B cells. FIGS. 9A and 9B show representative spleen sample from a female NOD mouse being dosing with water for 4 weeks. Pancreas isolate was stained, analyzed and gated in the same way, and the data were normalized in fold change to control. FIG. 9C shows gates for thymocytes.

FIG. 10 shows deconvoluted mass spectrum for WPI powders. The mass displayed is from 3,000 to 21,500 Da. The powders are highly purified and contain mainly α-lactalbumin (α-La, 14,178 Da) and β-lactoglobulin (β-Lg, variant B: 18,277 Da; A: 18,363 Da). The two peaks with an increase in molecular weight of 324 Da of β-Lg variants were probably resulted from one lactose attachment during powder manufacture.

FIGS. 11A to 11D show effect of EGPs on blood glucose levels in healthy mice. C57BL/6 females (6-8 weeks old) were gavaged with water, glucose solution (14.1 mg/ml), NR, EGPs or AGEs. FIG. 11A shows BGL change after orally challenged with glucose solution. FIG. 11B shows body weight after orally challenged with glucose solution. FIG. 11C shows resting BGL after orally challenged with glucose solution. Significance was detected at week 2, 6, 7 and 8, and shown in the table. FIG. 11D shows GTT and ITT after dosing for 8 weeks (mean±SE, n=5-6). a, b, c, P<0.05.

FIGS. 12A and 12B shows histopathological assessment of the pancreatic immune infiltrates. After being treated for 4 weeks, pancreases from non-diabetic NOD females were used for histopathological evaluation of the inflammation in β-islets. FIG. 12A shows representative β-islets for each score with the white numbers in the left corner indicating the inflammation score. White arrows indicate the infiltrated immune cells. FIG. 12B shows statistical analysis of the histopathological scores. Numbers indicate the total animals used and the numbers in parenthesis indicate the total islets evaluated.

FIGS. 13A to 13C show chronic exposure to EGPs reduces the prostatic inflammation. After dosing for 3 or 6 months, the mice were euthanized and the urogenital organs were harvested. Longitudinal sections were H&E stained, and the inflammations associated with the 4 lobes were scored. Representative images for each score are shown: black arrows indicate scattered or aggregated leukocyte infiltrates. The inflammatory statuses of NR and EGP groups at month 3 and 6 are summarized in the last panels. Immune cell infiltration was only detected for dorsal (FIG. 13A) and lateral (FIG. 13B) prostates. In addition to histological assessment, the inflammatory infiltrates (FIG. 13C) (i.e., macrophages, CD4+ T cells, CD8+ T cells, B cells) in the anterior prostate (AP) after 6-month treatment were quantitated by flow cytometry (mean±SEM, n=5-6). *, p<0.05.

FIG. 14 shows EGPs alter the white blood cells (WBC) in the circulation. The hematology analysis with differentials was conducted, and the numbers of WBC, neutrophils, lymphocytes, monocytes and eosinophils were shown (mean±SEM, n=5-6). **, p<0.01. One blood sample in the EGP group had clots, so the analysis of this sample was not done.

FIGS. 15A to 15E shows EGPs decrease the numbers of splenic leukocytes without altering the spleen weight. FIG. 15A shows spleens harvested and weighted. FIG. 15B shows splenic leukocyte number was significantly decreased by EGPs. The analysis of macrophages, CD4+ T cells, CD8+ T cells and B cells are summarized in FIGS. 15C-15E (mean±SEM, n=6). *, p<0.05; **, p<0.01.

FIG. 16 is a heatmap of cytokines/chemokines regulated by NR and EGPs in male NOD mice treated for 6 months. The average concentrations of cytokines/chemokines of NR groups are shown (pg/ml), and those of EGP groups were expressed as % change of NR. All averages and SEM were shown in Table 5.

FIGS. 17A to 17D show the composition of gut microbiome based on 16S rRNA sequencing in NOD males treated with EGPs or NR for 6 months. FIG. 17A show Weighted UniFrac beta diversity difference between NR (black) and EGPs (gray). FIG. 17B shows taxonomy of gut microbiome shown at the phylum level. Linear Discriminant Analysis Effective Size (LEfse) results for genus level (FIG. 17C) and species level (FIG. 17D) are shown. N=6.

FIG. 18A and 18B show correlational analysis using Spearman's correlation test. FIG. 18A shows significantly regulated immune endpoints and microbes at genus level correlated. FIG. 18B shows significantly regulated Bacteroides sp. correlated with immune endpoints. Positive correlation, + (p<0.05), + (p<0.01); negative correlation, − (p<0.05), −(p<0.01).

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, biology, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

The term “nutraceutical” is recognized in the art and is intended to describe specific chemical compounds found in foods that can prevent disease or ameliorate an undesirable condition. A nutraceutical can be in the form of a dietary supplement, a nutraceutical, a food additive, a food product, a complex carbohydrate, flour, sugar, a beverage, etc., or any combination thereof.

The term “nutraceutically acceptable” refers to those compounds, materials, compositions, and/or dosage forms which are, within the scope of sound medical judgment, suitable for oral consumption by human beings and animals without excessive toxicity, irritation, allergic response, or other problems or complications commensurate with a reasonable benefit/risk ratio.

The term “subject” refers to any individual who is the target of administration or treatment. The subject can be a vertebrate, for example, a mammal. Thus, the subject can be a human or veterinary patient. The term “patient” refers to a subject under the treatment of a clinician, e.g., physician.

The term “therapeutically effective” refers to the amount of the composition used is of sufficient quantity to ameliorate one or more causes or symptoms of a disease or disorder. Such amelioration only requires a reduction or alteration, not necessarily elimination.

The disclosed early glycation products (EGPs), and nutraceutical compositions comprising same, can be produced using standard techniques according to the methods described herein.

In some embodiments, this method involves dissolving a whey protein-containing material, or other proteins that can react with glucose to form glycation products, and glucose in water, freeze-drying the solution to produce a powder, and incubated the powder under conditions suitable for a Maillard reaction to produce the desired glycation.

The whey protein-containing material may comprise one or more of the following: whey protein isolate (WPI), whey protein concentrate (WPC), whey powder, milk protein concentrate (MPC), milk protein isolate (MPI) and skim and whole milk powder.

The reducing sugar can be glucose or others including galactose, glyceraldehyde, fructose, ribose, and xylose. The reducing sugar may be inherently present in the whey protein-containing material or it may be added. Preferably the reducing sugar is present in a molar ratio of free amino groups and reducing ends at 1:2.

In some embodiments, optimal glycation involves a water activity of between 0.4-0.6 a_{W}, where the highest glycation speed is achieved.

In some embodiments, optimal glycation involves a temperature of between 30 and denaturation temperature.

Once this level of glycation is reached, the storage conditions can be changed to inhibit further progression of the Maillard reaction. For example, the temperature can be reduced to below 20° C. and/or the water activity can be reduced to below 0.2 a_{W}.

Nutraceutically acceptable carriers assist or make possible the formation of a dosage form for a bioactive material and include diluents, binding agents, lubricants, glidants, disintegrants, coloring agents, and flavorants and nutrients. A carrier is nutraceutically acceptable if, in addition to performing its desired function, it is non-toxic, well tolerated upon ingestion, and does not interfere with absorption of bioactive materials. The nutraceutically acceptable carrier can be comprised of one or more binders, excipients, buffers, and flavorants and the flavorants may be selected from calcium carbonate, dextrose, sodium carbonate, magnesium stearate, mannitol, sorbitol, and xylitol. The binders, excipients, buffers, and flavorants and the flavorants can be selected from calcium carbonate, dextrose, sodium carbonate, magnesium stearate, mannitol, sorbitol, and xylitol.

In various aspects, a nutraceutical composition which can be in the form of a solid powder, caplets, tablets, lozenges, pills, capsules, or a liquid, and which may be administered alone or in suitable formulation with other components. For example, the nutraceutical composition of the present invention may be administered in one or more caplets or lozenges as practical for ease of administration. Each of the vitamins and minerals is commercially available, and can be blended to form a single composition or can form multiple compositions, which may be co-administered. More preferably, the composition of the present invention is in the form of a powder form for subsequent reconstitution by addition of a liquid into a beverage for consumption by the patient.

To prepare the nutraceutical compositions of the present disclosure, a composition prepared by the disclosed selective deletion chromatography methods may be formulated as intimate admixture with a suitable nutraceutically acceptable carrier according to conventional compounding techniques. The nutraceutically acceptable carrier may take a wide variety of forms depending upon the form of the preparation desired for administration, e.g., oral administration as, for example but not limited to, drug powders, crystals, granules, small particles (which include particles sized on the order of micrometers, such as microspheres and microcapsules), particles (which include particles sized on the order of millimeters), beads, microbeads, pellets, pills, microtablets, compressed tablets or tablet triturates, molded tablets or tablet triturates, and in capsules, which are either hard or soft and contain the composition as a powder, particle, bead, solution or suspension. The nutraceutical composition can also be sublingual, nasal, topical, or parenteral administration. In various aspects, the nutraceutical composition can be formulated as a controlled release system.

In preparing the nutraceutical composition in a dosage form selected from oral, topical and parenteral, any usual media may be utilized. For liquid preparations (e.g., suspensions, elixirs, and solutions), media containing, for example water, oils, alcohols, flavoring agents, preservatives, coloring agents and the like may be used. Carriers such as starches, sugars, diluents, granulating agents, lubricants, binders, disintegrating agents and the like may be used to prepare oral solids (e.g., powders, caplets, pills, tablets, capsules, and lozenges). Controlled release forms may also be used. Because of their ease in administration, caplets, tablets, pills, and capsules represent the most advantageous oral dosage unit form, in which case solid carriers are employed. If desired, tablets may be sugar coated or enteric coated by standard techniques. All of these pharmaceutical carriers and compositions are well known to those of ordinary skill in the art. See generally, e.g., Wade & Waller, Handbook of Pharmaceutical Excipients (2nd ed. 1994).

In various aspects, the nutraceutical composition can comprise any nutraceutically acceptable excipient, carrier or mixture thereof. As used herein, the term “nutraceutically acceptable excipient or carrier” refers to a non-toxic, inert solid, semi-solid, diluent, encapsulating material or formulation auxiliary of any type. Exemplary excipients include, but are not limited to diluents or fillers, such as dextrates, dicalcium phosphate, calcium sulfate, lactose, cellulose, kaolin, mannitol, sodium chloride, dry starch, sorbitol, sucrose, inositol, powdered sugar, bentonite, microcrystalline cellulose, or hydroxypropylmethylcellulose may be added to the inhibitor molecule to increase the bulk of the composition. Also, binders, such as but not limited to, starch, gelatin, sucrose, glucose, dextrose, molasses, lactose, acacia gum, sodium alginate, extract of Irish moss, panwar gum, ghatti gum, mucilage of isapgol husks, carboxymethylcellulose, methylcellulose, polyvinylpyrrolidone, Veegum and starch arabogalactan, polyethylene glycol, ethylcellulose, and waxes, may be added to the supplement to increase its cohesive qualities. Additionally, lubricants, such as but not limited to, talc, magnesium stearate, calcium stearate, stearic acid, hydrogenated vegetable oils, polyethylene glycol, sodium benzoate, sodium acetate, sodium chloride, leucine, carbowax, sodium lauryl sulfate, and magnesium lauryl sulfate may be added to the supplement. Also, glidants, such as but not limited to, colloidal silicon dioxide or talc may be added to improve the flow characteristics of a powdered supplement. Finally, disintegrants, such as but not limited to, starches, clays, celluloses, algins, gums, crosslinked polymers (e.g., croscarmelose, crospovidone, and sodium starch glycolate), Veegum, methylcellulose, agar, bentonite, cellulose and wood products, natural sponge, cation-exchange resins, alginic acid, guar gum, citrus pulp, carboxymethylcellulose, or sodium lauryl sulfate with starch may also be added to facilitate disintegration of the supplement in the intestine.

In various aspects, the disclosed compositions prepared by the disclosed selective deletion chromatography methods can be formulated to protect the composition from degradation by the acidic conditions of the stomach and from interactions with proteins, such as pepsin, present in the stomach. Such a formulation may include a pH-dependent enteric coating to prevent release until after gastric emptying. Thus, in some aspects, the nutraceutical composition can be enteric coated.

An enteric coated nutraceutical composition can be formulated as enteric coated tablets, beads or granules, which may optionally contain a lubricant such as, but not limited to, magnesium stearate.

The enteric coating may include one or more pH dependent polymers. The pH dependent polymers may remain intact at pH values lower than about 4.0 and dissolve at pH values higher than 4.0, preferably higher than 5.0, most preferably about 6.0. Exemplary pH-dependent polymers include, but are not limited to, methacarylic acid copolymers, methacrylic acid-methyl methacrylate copolymers (e.g., EUDRAGIT® L100 (Type A), EUDRAGIT® S100 (Type B), Rohm GmbH, Germany; methacrylic acid-ethyl acrylate copolymers (e.g., EUDRAGIT® L100-55 (Type C) and EUDRAGIT® L30D-55 copolymer dispersion, Rohm GmbH, Germany); copolymers of methacrylic acid-methyl methacrylate and methyl methacrylate (EUDRAGIT® FS); terpolymers of methacrylic acid, methacrylate, and ethyl acrylate; cellulose acetate phthalates (CAP); hydroxypropyl methylcellulose phthalate (HPMCP) (e.g., HP-55, HP-50, HP-55S, Shinetsu Chemical, Japan); polyvinyl acetate phthalates (PVAP) (e.g., COATERIC®, OPADRY® enteric white OY-P-7171); polyvinylbutyrate acetate; cellulose acetate succinates (CAS); hydroxypropyl methylcellulose acetate succinate (HPMCAS), e.g., HPMCAS LF Grade, MF Grade, HF Grade, including AQOAT® LF and AQOAT® MF (Shin-Etsu Chemical, Japan); Shinetsu Chemical, Japan); shellac (e.g., MARCOAT™ 125 & MARCOAT™ 125N); vinyl acetate-maleic anhydride copolymer; styrene-maleic monoester copolymer; carboxymethyl ethylcellulose (CMEC, Freund Corporation, Japan); cellulose acetate phthalates (CAP) (e.g., AQUATERIC®); cellulose acetate trimellitates (CAT); and mixtures of two or more thereof at weight ratios between about 2:1 to about 5:1, such as, for instance, a mixture of EUDRAGIT® L 100-55 and EUDRAGIT® S 100 at a weight ratio of about 3:1 to about 2:1, or a mixture of EUDRAGIT® L 30 D-55 and EUDRAGIT® FS at a weight ratio of about 3:1 to about 5:1.

The pH dependent polymers can be incorporated in an amount from about 10% to 90%, preferably from about 20% to 80% and most preferably from about 30% to 70% by weight of the dosage unit or supplement. The polymer(s) can be incorporated into the formulation either prior to or after granulation or they can be added into the supplement either as a dry material, or they can be dispersed or dissolved in an appropriate solvent, and dispersed during granulation.

An enteric coated nutraceutical composition can include enteric coated beads in a capsule, enteric coated microspheres in a capsule, enteric coated microspheres provided in a suspension or mixed with food, which are particularly convenient for pediatric administration, and enteric coated compressed tablets. The capsule can be a hard-shell gelatin capsule or a cellulose capsule. In particular, the composition or herbal supplement may be formulated as an enteric coated capsule. In certain embodiments, an herbal supplement comprising an anti-spasmodic composition, such as peppermint oil is administered in a tablet form that is backfilled with microcrystalline cellulose. Alternatively, the peppermint oil may be administered without the use of an enteric coating.

In some aspects, the nutraceutical composition can be directly compressed, with or without any excipients, into a tablet or other herbal supplement having a nutraceutically acceptable hardness and friability. Preferably, the directly compressible herbal supplement can be compressed into tablets having a hardness of greater than 4 kp (kiloponds), preferably a hardness of 8 to 14 kp, more preferably a hardness of 10 to 13 kp. A directly compressible composition can be compressed into a tablet that has a friability of not more than 1% loss in weight, preferably less than 0.8% loss in weight, more preferably less than 0 5% loss in weight.

The administration of the nutraceutical composition will typically be administered over several weeks in a manner, which provides an effective amount of each of the desired nutrients so as to ensure that the demand for the nutrients by the induced mitochondrial energy production or stimulated ATP production, is satisfied.

The nutraceutical composition may be formulated in a unit dose form. Such unit dose will generally comprise an amount in the range of from about 0.01 μg to about 15,000 mg, about 0.1 μg to about 1000 mg, and about 0.1 μg to about 500 mg of the composition. The nutraceutical composition may be taken in doses, one to six times a day in a manner such that the total daily dose for a 70 kg adult will generally be in the range of from about 0.1 μg to 40,000 mg, about 1 μg to 10,000 mg, or about 0.5 μg to 20,000 mg. The daily dose of the nutraceutical composition can be about 0.1 μg mg/kg/day to about 50 mg/kg/day body weight, about 0.5 μg mg/kg/day to about 40 mg/kg/day, or about 1.0 μg mg/kg/day to about 20 mg/kg/day are effective in one or several administrations per day in order to obtain the desired results. The administered dose depends on the age, state of health, and weight of the recipient, the extent of various enzymatic activities in the recipient, the type of additional treatments that may be carried out at the same time, and the type of desired effect. During the course of the treatment, the concentration of the nutraceutical compositions may be monitored to ensure that the desired level is maintained.

The nutraceutical composition may be administered in the form of daily doses such as in liquid, tablet, capsule or pill form. Alternatively, the nutraceutical composition may be administered via one or more dosage forms each comprising varying amounts of at least one of water-soluble and fat-soluble energy nutrients over a period of time.

The nutraceutical composition may be administered in beverages, tonics, infusions, or food-stuffs alone, or in combination with other dietary supplements or therapeutics.

Disclosed herein are nutraceutical compounds (EGPs) and methods for reducing inflammation. The inflammatory conditions may be a chronic inflammatory disease and may be selected from, for example, arthritis such as rheumatoid arthritis, sinusitis, allergic disorders such as asthma, psoriasis, acne, inflammatory bowel diseases, chronic fatigue syndrome, autoimmune disorders such as systemic lupus erythematosus, Sjögren's syndrome, inflammation of the prostate, inflammation of the urinary tract, pancreatitis, vasculitis, diabetes, inflammation of the feet including gout, and period pain.

In some embodiments, the disclosed EGPs can be used to treat or prevent diabetes, such as type 1 diabetes, type 2 diabetes, or gestational diabetes, in a subject in need thereof. The compositions disclosed herein may be administered prophylactically to patients or subjects who are at risk for diabetes. Thus, the method can further comprise identifying a subject at risk for diabetes prior to administration of the herein disclosed compositions. Therefore, in some embodiments, the subject has been diagnosed with diabetes, pre-diabetes, or a metabolic disorder.

The exact amount of the compositions required will vary from subject to subject, depending on the species, age, weight and general condition of the subject, the severity of the allergic disorder being treated, the particular nucleic acid or vector used, its mode of administration and the like. Thus, it is not possible to specify an exact amount for every composition. However, an appropriate amount can be determined by one of ordinary skill in the art using only routine experimentation given the teachings herein. For example, effective dosages and schedules for administering the compositions may be determined empirically, and making such determinations is within the skill in the art. The dosage ranges for the administration of the compositions are those large enough to produce the desired effect in which the symptoms disorder are effected. The dosage should not be so large as to cause adverse side effects, such as unwanted cross-reactions, anaphylactic reactions, and the like. Generally, the dosage will vary with the age, condition, sex and extent of the disease in the patient, route of administration, or whether other drugs are included in the regimen, and can be determined by one of skill in the art. The dosage can be adjusted by the individual physician in the event of any counterindications. Dosage can vary, and can be administered in one or more dose administrations daily, for one or several days. Guidance can be found in the literature for appropriate dosages for given classes of pharmaceutical products.

A number of embodiments of the invention have been described. Nevertheless, it will be understood that various modifications may be made without departing from the spirit and scope of the invention. Accordingly, other embodiments are within the scope of the following claims.

### EXAMPLES

Example 1: Glycated Whey Proteins Protect NOD Mice against Type 1 Diabetes by Increasing Anti-Inflammatory Responses and Decreasing Autoreactivity to Self-Antigens

Glycated whey proteins were shown to be protective against type 1 diabetes in Example 1, suggesting a potential application as medical food. To determine if the protection could be extended to other autoimmune diseases, aged male non-obese diabetic (NOD) mice that develop a wide spectrum of autoimmune pathologies, including spontaneous autoimmune prostatitis, were used. After a 6-month oral exposure to whey protein-derived early glycation products (EGPs), EGP-treated NOD mice had an increased survival rate, decreased macrophage infiltration in anterior lobe and decreased inflammation in the prostate when compared to the mice that received non-reacted control. The systemic immunity was regulated towards anti-inflammation, evidenced by an increase in serum IL-10 level and decreases in total splenocytes, splenic M1 macrophages, CD4+ T cells, CD8+ T cells and B cells. Consistent with an overall anti-inflammatory status, the gut microbiome was altered in abundance but not diversity, with increased Allobaculum, Anaerostipes, Bacteroides, Parabacteroides and Prevotella, and decreased Adlercreutzia and Roseburia at the genus level. Moreover, increased Bacteroides acidifaciens correlated with most immune parameters measured. Collectively, chronic oral exposure to EGPs produced an anti-inflammatory effect in aged male NOD mice, which might contribute to the protective effects against spontaneous autoimmune prostatitis and/or other organ specific autoimmune diseases.

### Material and Methods

### EGP Preparation and Identification

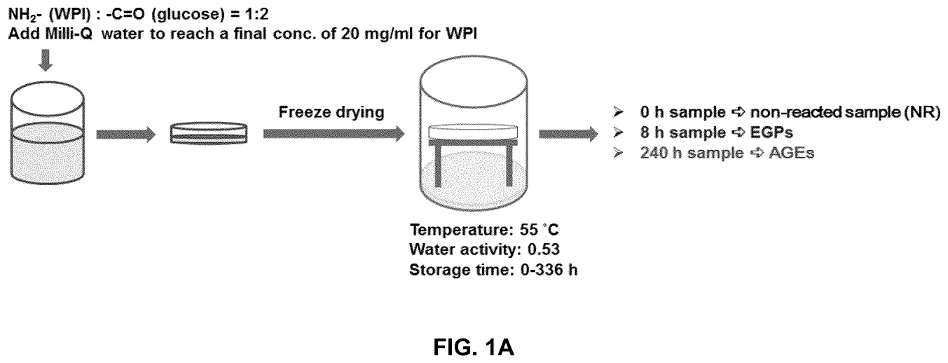

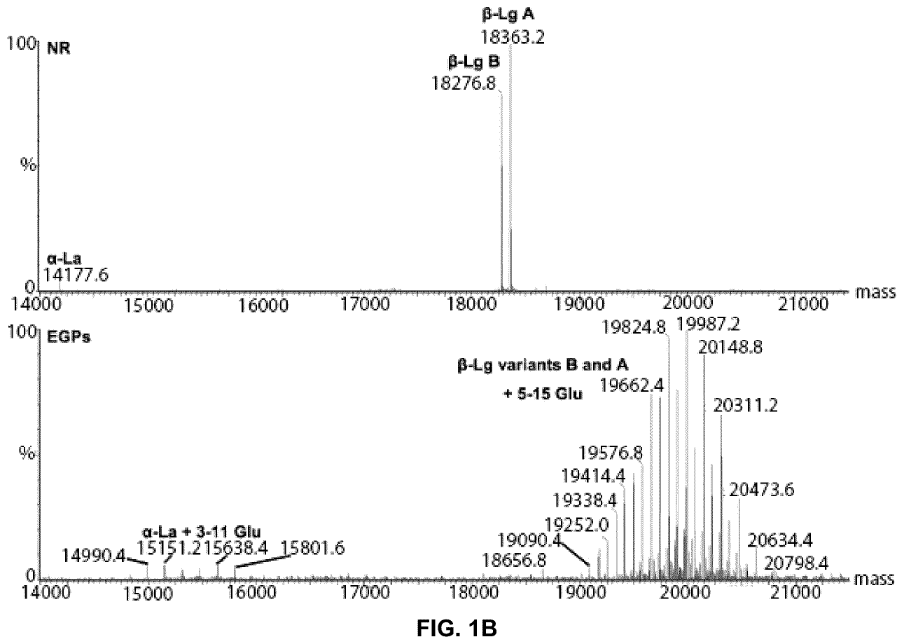

Dietary EGPs were generated from whey protein isolate (WPI, Fonterra (USA) Inc, Rosemont, IL) and glucose (Sigma-Aldrich, St. Louis, MO). They were prepared as described before [Chen Y, et al. Mol Nutr Food Res, 2018 62:e1700641], and summarized in a simplified flow diagram (FIG. 1A). In brief, a solution containing WPI and glucose was freeze-dried, and the powders were further incubated in sealed desiccator maintained at a_{W} 0.53 and 55° C. for different durations. Glycation markers were quantitated and the 8 h samples were determined as EGPs [Chen Y, et al. Mol Nutr Food Res, 2018 62:e1700641]. The reacted sample were stored at −20° C. prior to use, and thawing in a sealed desiccator containing silica gel at room temperature. The compositions of WPI and glycated products were analyzed by LC-MS (Bruker Daltonics, Billerica, MA) equipped with BioBasic-4 column (Thermo Fisher Scientific, Waltham, MA). The samples were dissolved in Milli-Q water at 1 mg/ml, and filtered through a 0.45 μm filter membrane. A 2 μl sample was injected at minute 11. Solvent A was aqueous solution containing 0.1% formic acid and solvent B was 100% acetonitrile. The elution was performed at a flow rate of 50 μl/min from 0 to 2% B within 11 min and to 100% in the following 50 min. A positive ionization mode was used, and the cone voltage was 45 V. The m/z range was 400-3000 with scan time of 5 s (0.2 s interval). The data were analyzed on MassLynx V4.1 and MassEnt1 (Waters Co., Milford, MA), and the average degree of substitution per protein (DSP) was calculated as the following formula [Chen Y, et al. Food Res Int, 2013 54:1560-8]:

$$Average D S P = {\sum }_{i = 0}^{n} i \times {I}_{i} / {\sum }_{i = 0}^{n} {I}_{i}$$

where i is the number of glucose attached; I is the peak intensity of proteins attached with i glucose.

### Mice and Treatment

C57BL/6 mice and NOD mice obtained from the Charles River Laboratories (Wilmington, MA) and Taconic Biosciences (Rensselaer, NY), respectively, were housed in Coverdell Vivarium at the University of Georgia (UGA). All mice were maintained on a 12-h dark/light cycle at 21-24° C. with 20-60% relative humidity, with access to food and filtered tap water ad libitum. Mice aged 0-4 week were kept on breeder chow (5058, PicoLab® Rodent Diet 20, LabDiet, MO), and switched to normal chow (5053) afterwards. All mice were euthanized by CO₂ inhalation followed by cervical dislocation. The use of the animals was approved by UGA Institutional Animal Care and Use Committee (IACUC). Since there was no in vivo reference dose available for EGPs, the dose (600 mg/kg body weight (BW)/day) was determined following previous reports of in vivo dietary AGE-treatment [Cai W, et al. Proc Natl Acad Sci U S A, 2012 109:15888-93], which would give the mouse an equivalent amount of AGEs to that they obtained from the diet (FIG. 8). Toxicity (3 months duration) of both EGPs and AGEs was tested in female and male C57BL/6 mice prior to following experiments. No difference on BW was detected, suggesting that these glycation products at this dose did not generate overt toxicity.

### MLD STZ-Induced Hyperglycemia in C57BL/6 Females

C57BL/6 female mice (6-8 weeks old) were randomly separated into 5 groups (5-6 per group), and gavaged with non-reacted samples (NR), EGP, AGEs, autoclaved purified water and glucose solution (14.1 mg/ml) in the same volume. After 8 weeks, the mice were rendered diabetic with STZ injection (50 mg/kg BW/day intraperitoneally (i.p.) in citrate buffer for 4 consecutive days). Dosing with glycation products were continued for another 4 weeks.

### NOD Mice

NOD females (6-8 weeks old) were randomly separated into 3 groups (4 in each group with one repeat), and gavaged with NR, EGP and autoclaved purified water in the same volume for 4 weeks. In the secondary experiment, two groups of NOD females (6-8 weeks old, 10-11 in each group) were treated in the same way for 8 weeks. In the third experiment, non-diabetic NOD males were randomly separated into 2 groups (15-13 in each group, age matched) and gavaged with NR and EGPs for up to 6 months.

### T1D Relevant Endpoints: BW, BGL, Glucose Tolerance Test (GTT), Insulin Tolerance Test (ITT), Food and Water Consumptions

BW, food and water consumptions were measured weekly. BGL was measured weekly or bi-weekly in small sample of venous blood (tail nick) with Bayer's CONTOUR blood glucose meter (Bayer Health Care LLC, Mishawaka, IN). Diabetes was defined as BGL>200 mg/dl in two consecutive weeks. For GTT, mice were fasted for 16 h, and i.p. injected with glucose water solution at the dose of 2 g/kg BW. For ITT, mice were fasted for 4 h, and i.p. injected with bovine insulin (Sigma-Aldrich) PBS solution at the dose of 6.4×10⁻³ mg/kg BW. To determine if the glucose in the glycation samples could elevate the non-fasting BGL, two groups of C57BL/6 females were used for orally challenged GTT: non-fasted mice were gavaged with water or 14.1 mg/ml glucose solution at 0.01 ml/g BW. The BGL was measured at 0, 15, 30, 60 and 120 min, and all mice were prevented from reaching food during the tests.

### Histopathological Scoring for the Pancreatic β-Islets

A section of tissue from the pancreas head were dissected and fixed in 10% buffered formalin. The hematoxylin and eosin (H&E) staining was performed by Clinical Pathology Laboratory (College of Veterinary Medicine, UGA), and the slides were analyzed blindly on an Olympus BX41 light microscope (Olympus Corporation, Tokyo, Japan) by a board-certified pathologist using the criteria described in Table 1. For STZ-destructed pancreases, β-islet inflammation and vacuolation were scored. For NOD females, β-islet inflammation was graded.

### Tissue Processing and Flow Cytometry

Pancreatic immune infiltrates were purified following the protocol by Epshtein et al. [Epshtein A, et al. J Vis Exp, 2017 119:e55344] with small modifications. A section of 0.1-0.15 g tissue from the pancreas head was dissected, cut into small pieces, and placed into 2 ml cold PBS. A 1 ml of digestive buffer was added to reach the final concentrations of collagenase (Sigma-Aldrich) at 0.05 mg/ml and DNase (Sigma-Aldrich) at 5 U/ml. The tube was incubated at 37° C. for 30-45 min with the rotator speed at 20 rpm in a Robbins Scientific Model 1000 Hybridization Incubator. The digestion was stopped by adding 10 ml cold PBS, and the solution was centrifuged at 300×g at 4° C. for 8 min. The supernatant was removed, and the pellet was resuspended in 6 ml PBS and passed through a 40 μm-cell strainer placed on a 50 ml conical polypropylene tube. The original tube was washed using 7 ml PBS twice by passing through the cell strainer into the collection tube. The PBS was removed by centrifugation, and the cells were resuspended in PBS to reach a proper concentration (10⁶/ml) for flow cytometric analysis.

Spleen was separated and placed into 3 ml cold PBS. Cell suspensions were prepared by mashing the spleen using the frosted ends of two microscope slides. Red blood cells were lysed using the ACK lysing buffer (Gibco by Life Technologies, Orand Island, NY) and the buffer was removed by centrifugation at 300×g at 4° C. for 8 min. The cell pellet was washed once using cold PBS and then resuspended in PBS. Thymus was separated and placed into 2 ml cold PBS. The single-cell suspensions were prepared the same way as spleen but without lysis.

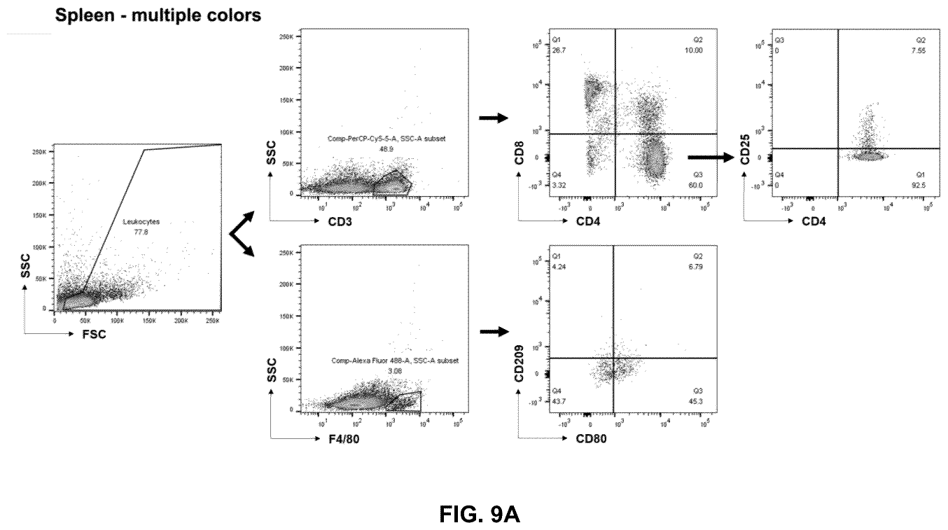

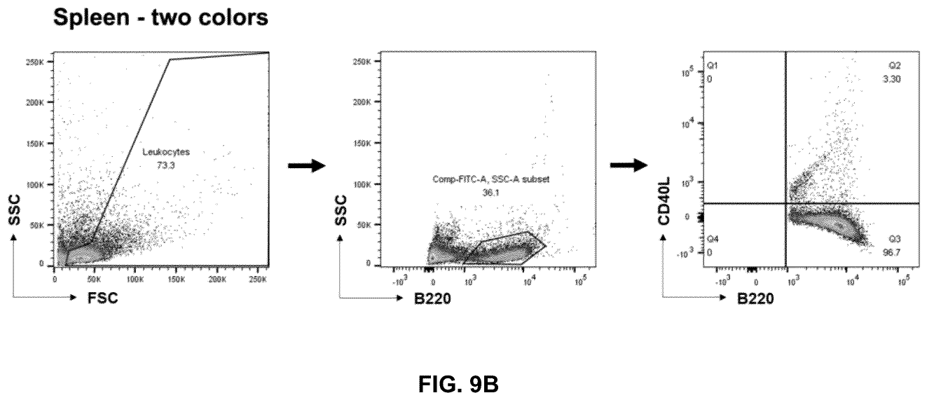

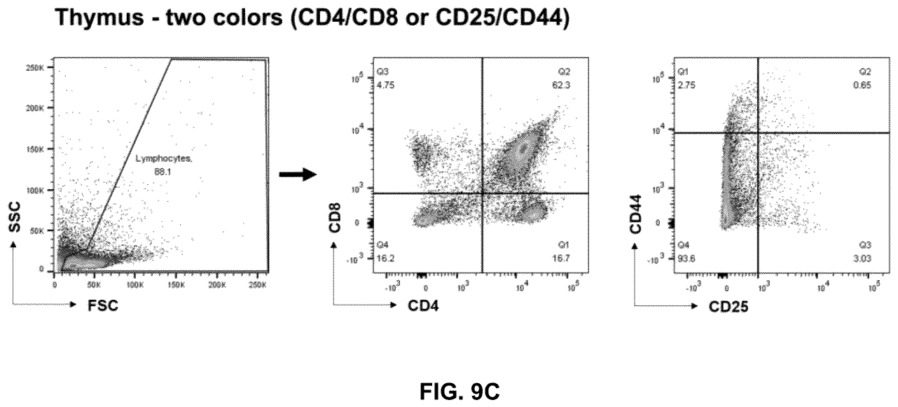

Splenic and pancreatic cells were stained for the following surface markers conjugated with fluorophores: CD3 (145-2C11, PerCP-Cy5.5, BD Pharmingen), CD 4 (RM4-5, V450, BD Horizon), CD8 (53-6.7, APC-H7, BD Pharmingen), CD25 (PC61, APC, BD Pharmingen), F4/80 (BM8, FITC, eBioscience), CD209 (LWC06, Alexa Fluor, Novus Biologicals), CD80 (16-10A1, PE-CD594, BD Horizon); B220 (RA3-6B2, FITC, eBioscience), CD40L (MR1, PE, eBioscience). Thymocytes were stained using CD4 (L3T4, PE, eBioscience) and CD8a (Ly-2, FITC, BD Pharmingen); CD44 (IM7, PE, BD Pharmingen) and CD25 (7D4, FITC, BD Pharmingen). Fluorescence Minus One (FMO) controls were performed for gating setup [Maecker HT, et al. Cytometry A, 2006 69:1037-42]. After adding the antibodies, cells were incubated at 4° C. in the dark for 30 min. The cells were washed, and acquired on a Becton Dickinson LSRII Flow Cytometer (BD Biosciences). The flow cytometric data were analyzed using FlowJo v10 (FlowJo, LLC, Ashland OR), and the gating strategies are shown in FIG. 9. Leukocytes were characterized as CD4⁺ T cells (CD3⁺CD4⁺CD8⁻), CD25⁺ regulatory T cells (CD3⁺CD4⁺CD8⁻CD25⁺), CD8⁺ T cells (CD3³⁰ CD4⁻CD8⁺), macrophages (F4/80⁺), M1 (F4/80⁺CD80⁺CD209−), M2 (F4/80⁺CD80⁻CD209⁺), B (B220⁺), CD40 ligand positive B cells (B220⁺CD40L⁺), and thymocytes (CD8/CD4 or CD24/CD44).

### Cytokine/Chemokine Quantitation

Blood was obtained from the orbital sinus after mouse being deeply anesthetized. The serum was collected and stored at −80° C. prior to use. Thirty-two cytokines/chemokines in the sera were detected by the bead-based multiplex ELISA technique using the MILLIPLEX MAP Mouse Cytokine/Chemokine Kit (Millipore, Billerica, MA) following the manufacturer's instructions. The beads were run on a Bio-Plex (Bio-Rad, Inc., Hercules, California), and the data was collected and analyzed using Bio-Plex Manager 6.1.1. The working range was 12.8-40,000 pg/ml for IL-13, and 3.2-10,000 pg/ml for the rest. IL-3 and IL-5 were not detected in the samples; IL-4 was below the lower limit of quantitation of the standard curve with some samples fell in the extrapolated range.

### Measurement of Immunoglobulin (Ig) Isotypes and Insulin Autoantibodies (IAAs)

The serum levels of Ig isotypes (i.e., IgM, IgG₁, IgG_{2b}, IgG_{2c}) were detected using ELISA Quantitation Kits (Bethyl Laboratories Inc., Montgomery, TX). IgG2c was a substitute for IgG₂ₐ in NOD mice because IgG₂ₐ was not expressed in inbred strains with Igh1-b allele [Martin RM, et al. J Immunol Methods, 1998 212:187-92]. The sera from NOD females were measured using two commercially available IgG₂ₐ antibodies (i.e., Bethyl, SouthernBiotech), and the O.D. was consistently found to be ˜0.2 at the dilution from 1/10 to 1/1000 (data not shown), which agreed with the previous study [Martin RM, et al. J Immunol Methods, 1998 212:187-92]. Therefore, an O.D.<0.2 was considered the background for all sera to eliminate the false positive caused by hemolysis. The 96 well flat-bottom high binding microplate was coated with 100 μl/well primary antibody (5 μg/ml) at 4° C. for overnight (16-18 h), and then blocked with 5% skim milk powder in 0.05% PBST at room temperature for 1 h. After washing with 0.05% PBST, a 100 μl standard or sample was added. The standard curve was prepared by diluting Mouse Reference Serum provided by the Manufacturer with the diluent (2% skim milk powder in 0.02% PBST). A series of dilutions was conducted for sera samples, and only the dilution with optimal detection was reported: IgM (1/5,000), IgG₁ (1/500,000), IgG_{2b} (1/20,000), IgG_{2c} (1/50,000). After 2 h incubation at room temperature, the plate was washed and a 100 μl HRP-conjugated secondary antibody was applied. The plate was incubated at room temperature at dark for 1 h, and then washed. A 100 μl Ultra TMB-ELISA Substrate Solution (Thermo Scientific, Rockford, IL) was added, and the reaction was stopped by an addition of 100 μl 1 M H₂SO₄ solution after 5-10 min. The absorbance was read at 450 nm in a Synergy 4 hybrid multi-mode microplate reader (BioTek Instrument, Inc., Winooski, VT).

For the IAA titers [Quintana FJ, et al. J Autoimmun, 2001 17:191-7; Wan X, et al. J Exp Med, 2016 213:967-78], the plates were coated overnight with bovine insulin (10 μg/ml in carbonate solution (pH=9.6), 100 μl) at 4° C. To check the specificity of the assay, diluted sera were divided into two aliquots and incubated in the presence or absence of 10 μg/ml insulin on ice for 1 h. HRP-conjugated goat anti-mouse IgM or anti-mouse IgG were used as the secondary antibodies (Bethyl). The O.D. threshold was 0.06, which was determined by a serial dilution from 1/5 to 1/2500. The other steps were the same as described above.

### Statistics

Data were presented as mean±SE. Comparisons of means were tested by one-way ANOVA using JMP Pro 13 (SAS Inc., Cary, NC). Tukey-Kramer post hoc test was conducted when the omnibus test was significant for the comparison of three or more groups. The comparisons of means between EGPs and water/NR were tested using Student's t test, and the survival curves were compared using Gehan-Breslow-Wilcoxon test performed on GraphPad Prism 6 (GraphPad Software, San Diego, CA).

### Results

### The Composition of EGPs

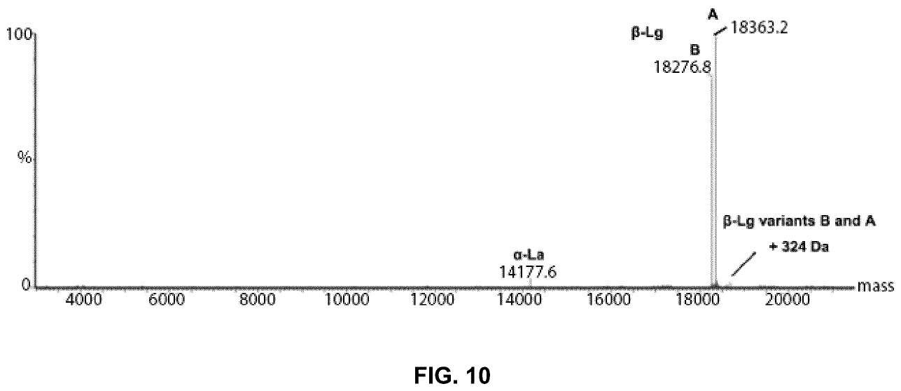

The composition of WPI powders was firstly verified by LC-MS. As shown in FIG. 10, the powders were highly purified and contained mainly α-lactalbumin (α-La, 14,178 Da) and two variants of β-lactoglobulin (β-Lg, variant B: 18,277 Da; A: 18,363 Da). The two peaks with an increase in molecular weight of 324 Da of β-Lg variants were probably resulted from 1 lactose attachment during powder manufacture, such as spray drying. When NR and EGPs were analyzed, the components in NR samples were highly consistent with WPI, suggesting that the freeze-drying steps did not generate glycation products (FIG. 1B, upper panel). After 8 h reaction, no original forms of α-La or β-Lg remained (FIG. 1B, lower panel). All the α-La reacted with 3-11 glucoses, with the 6-glucose attached α-La being the most abundant and the average DSP of 7.2. Both variants of β-Lg were attached by 5-15 glucoses. The 10-glucose attached form was the most abundant and the average DSP was 9.7 for both variants, which agreed with a previous study that the two variants showed similar reactivity during glycation [Chen Y, et al. J Agric Food Chem, 2012 60:10674-82].

### EGPs Have Minimal Effect on MLD-STZ-Induced Hyperglycemia

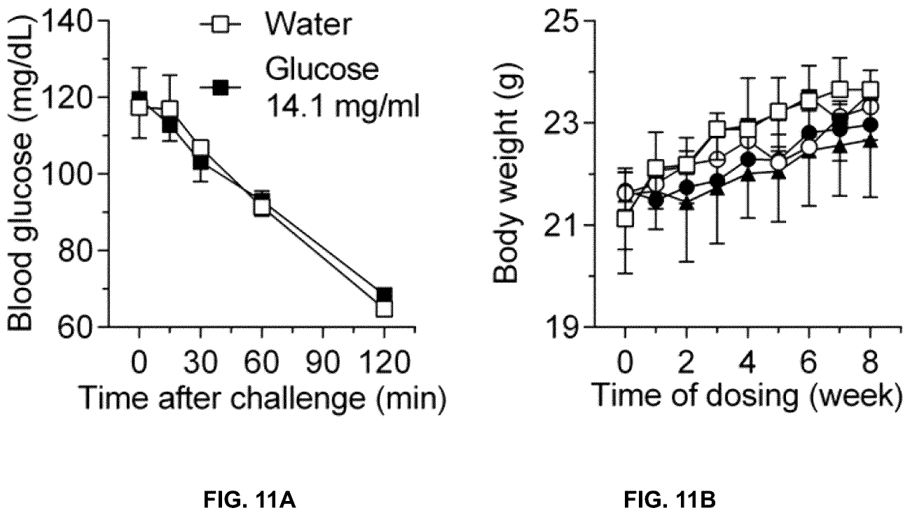

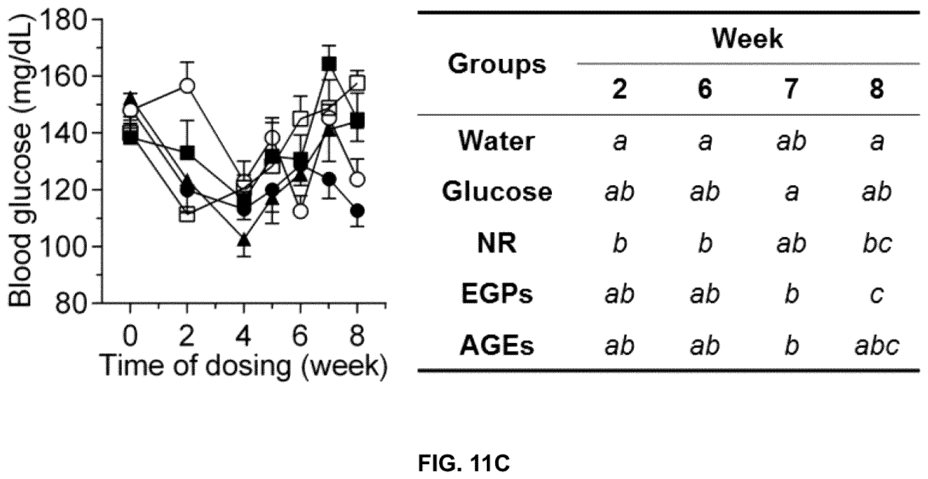

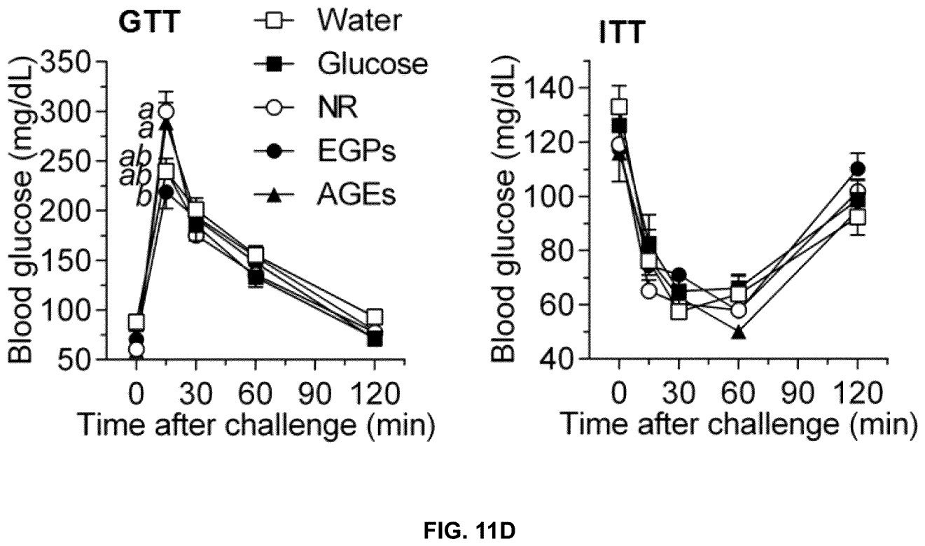

C57BL/6 females were pretreated with EGPs for 8 weeks to stabilize the levels of circulating EGPs, and the effects of EGPs on BGL in these healthy animals were monitored at the same time. In addition to water control, two additional controls including glucose solutions and NR were included because NR and glycation product samples contained glucose, which might affect the BGL. Therefore, GTT was conducted with oral challenge of the glucose solution that was equivalent to the amount of glucose in NR sample. The results showed that orally intake of this amount glucose did not elevate the BGL immediately after dosing in healthy mice (FIG. 11A). AGEs were used as a positive control since they were widely reported to be detrimental for both healthy and diabetic individuals [Cai W, et al. Proc Natl Acad Sci U S A, 2012 109:15888-93]. FIG. 11B showed that no significant difference was detected for BW during treatment, suggesting none of the treatments generated overt toxicity. For the non-fasting BGL, it stayed between 110-125 mg/dl in EGP group, while it fluctuated between 110-160 mg/dl in the 4 control groups (FIG. 11C). GTT was conducted after dosing for 8 weeks. The BGLs of EGP-treated group were significantly lower at 15 min after challenge when compared to those of NR and AGE-treated groups, although there were no differences compared to those of water-and glucose-treated groups (FIG. 11D). During ITT, no significant difference was detected at any time points among the groups. These results suggested that EGPs could stabilize BGL. Therefore, the effect on T1D was further studied in two T1D models.

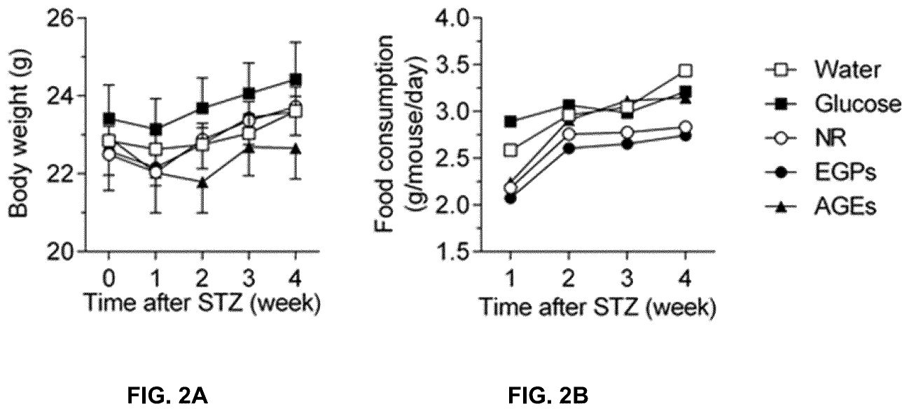

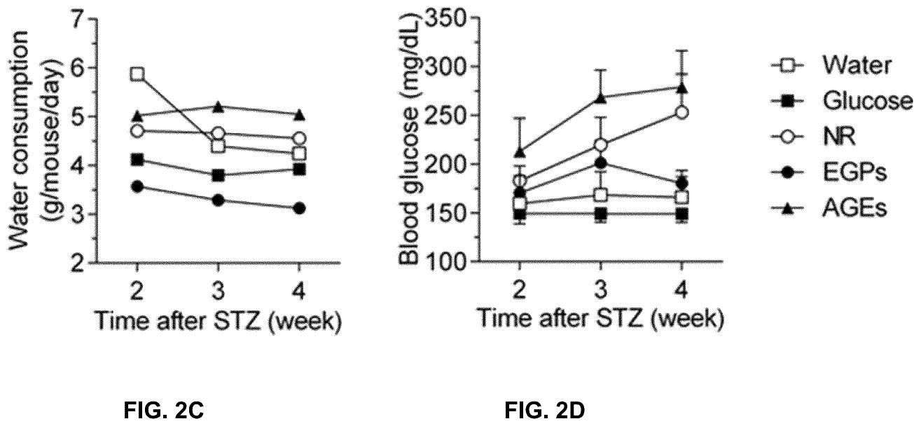

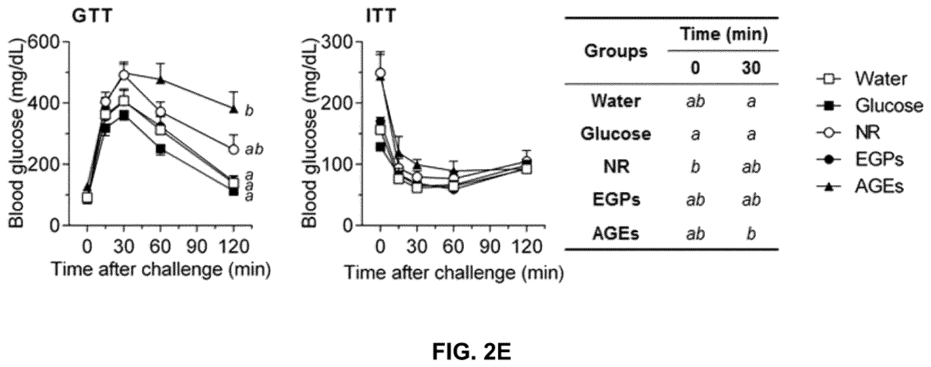

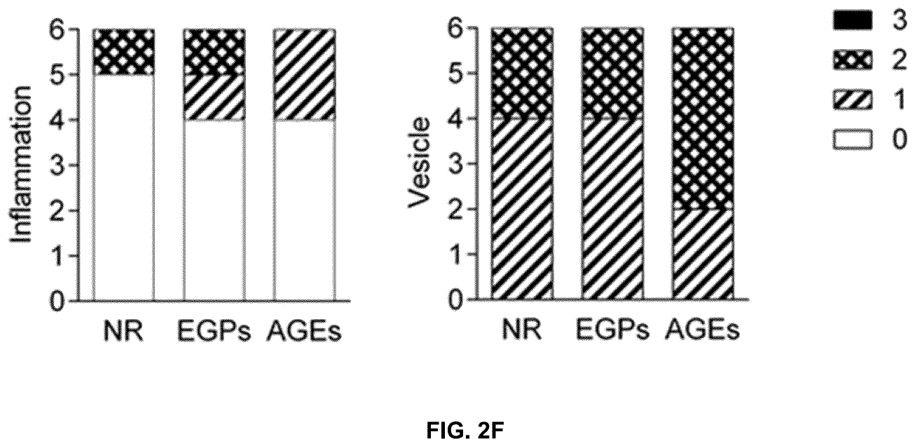

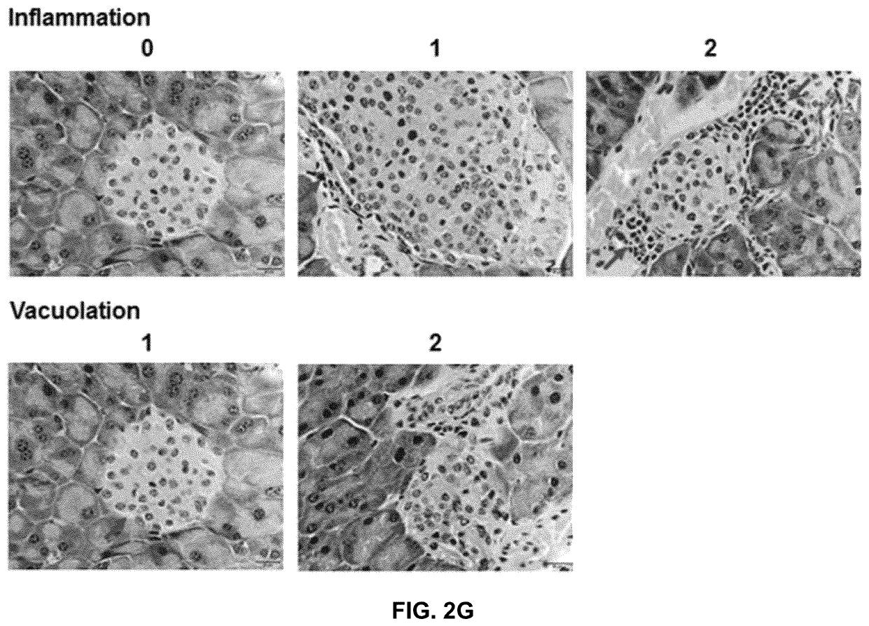

The first T1D model was the MLD-STZ-induced hyperglycemia in C57BL/6 females. After 8 weeks dosing, STZ was i.p. injected to specifically destroy pancreatic β-cells and thus induce hyperglycemia in these mice. After STZ injection, mice treated with glucose solution showed the least changes in BW, and water, NR and EGP-treated mice had moderate decreases in the BW while AGE-treated mice had the most decreases in BW (FIG. 2A). In addition, mice from the EGP group ate and drank the least (FIG. 2B-2C). The glucose solution-treated mice maintained the non-fasting BGL around 150 mg/dL after STZ injection; the non-fasting BGLs in the water and EGP groups slightly increased; however, NR and AGE-treated mice showed a continuous increase in their non-fasting BGL (FIG. 2D). During GTT, NR and AGE-treated mice had increased BGL more than the mice from the other three groups within the first 30 min, and AGE group had a significantly increased BGL at 120 min compared to water, glucose and EGP group (FIG. 2E, left panel). During ITT, NR treated mice showed the highest fasting BGL, followed by AGEs, NR, EGPs, water and glucose solution. At 30 min after insulin injection, AGE group had the highest BGL, followed by NR/EGPs and water/glucose solution (FIG. 2E, right panel). An overall evaluation of the diabetes severity suggested that AGEs>NR>EGPs, water≥glucose, based on the above various endpoints of T1D: BW, food and water consumption, non-fasting BGL, and BGL change during GTT and ITT. Histopathological assessment of β-islets was conducted from the aspects of inflammation and vacuolation, and the level of vacuolation but not inflammation correlated with the ranking of diabetes severity (FIG. 2F-G). Cytoplasmic vacuolation was due to the remarkable destruction of islets induced by STZ [Amniattalab A, et al. Iran J Pharm Res, 2016 15:493-500], and the results suggested that AGEs facilitated the destructive function of STZ while EGPs and NR control had similar effects.

### EGPs Delay TID Onset in NOD Females

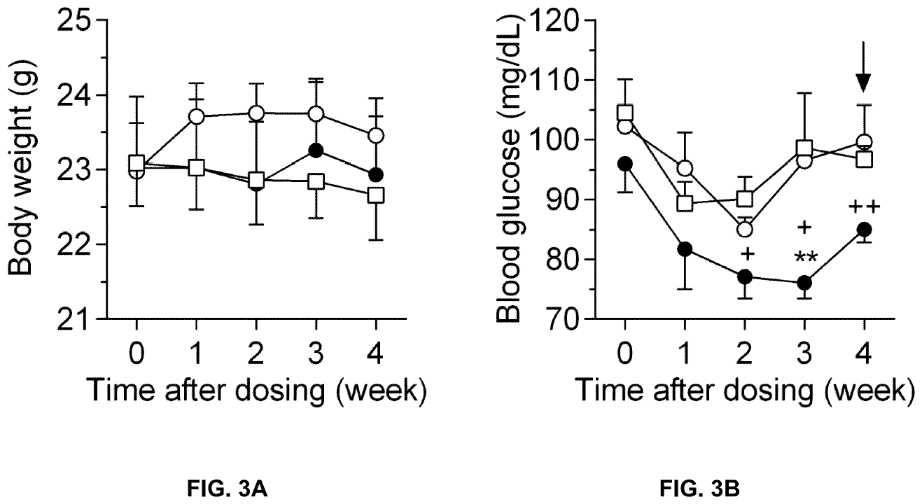

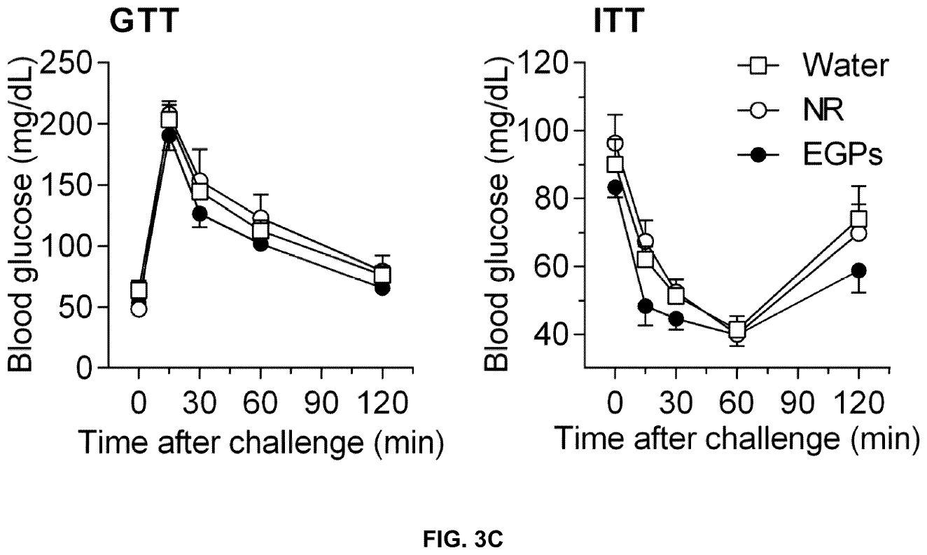

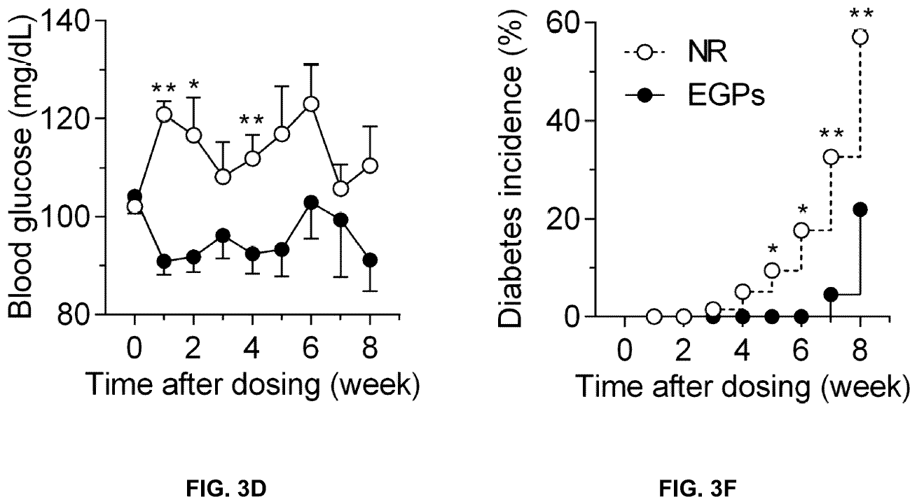

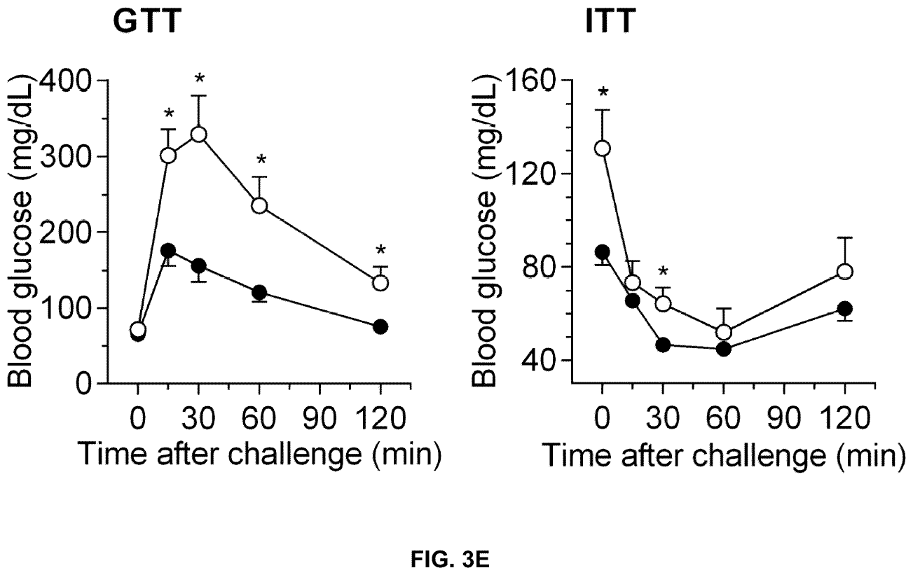

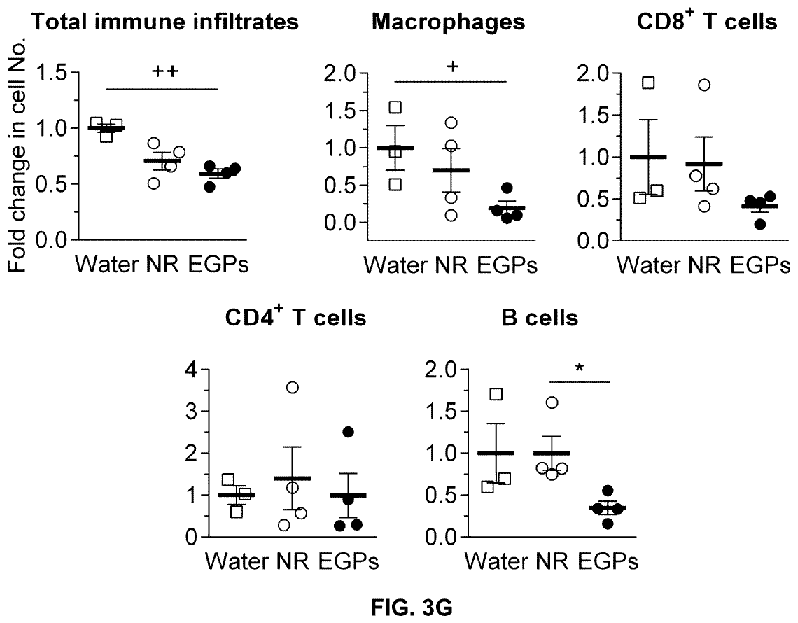

The other T1D murine model used was NOD mouse. NOD females were dosed with water, NR or EGPs for 4 weeks. There was no significant difference in BW between controls and EGPs (FIG. 3A) and organ weights including spleen, thymus, liver, kidney and heart (Table 1) that were commonly used as toxicity indications of test compounds. These observations suggested that NR or EGPs at this dose did not generate overt toxicity to NOD females. Comparing to NR and water controls, EGPs significantly decreased non-fasting BGL of the non-diabetic mice after dosing for 2 weeks (FIG. 3B), but did not alter the BGLs during GTT or ITT, which were conducted after dosing for 4 weeks (FIG. 3C). Another set of NOD females were continuously dosed with NR and EGPs for up to 8 weeks to monitor the non-fasting BGL and the response to glucose and insulin challenges (FIG. 3D-3E). EGPs significantly lowered the non-fasting BGL since week 1, increased the glucose metabolism during GTT, and increased the insulin sensitivity during ITT, when compared to NR control. Additionally, the T1D incidence was recorded: NR treated mice started to show T1D incidence at week 3 (9-11 weeks old) and had a total incidence close to 60% at week 8 (14-16 weeks old); in comparison, EGPs treated mice did not show T1D incidence until week 7 (13-15 weeks old) and had an overall incidence at approximately 20% (FIG. 3F).

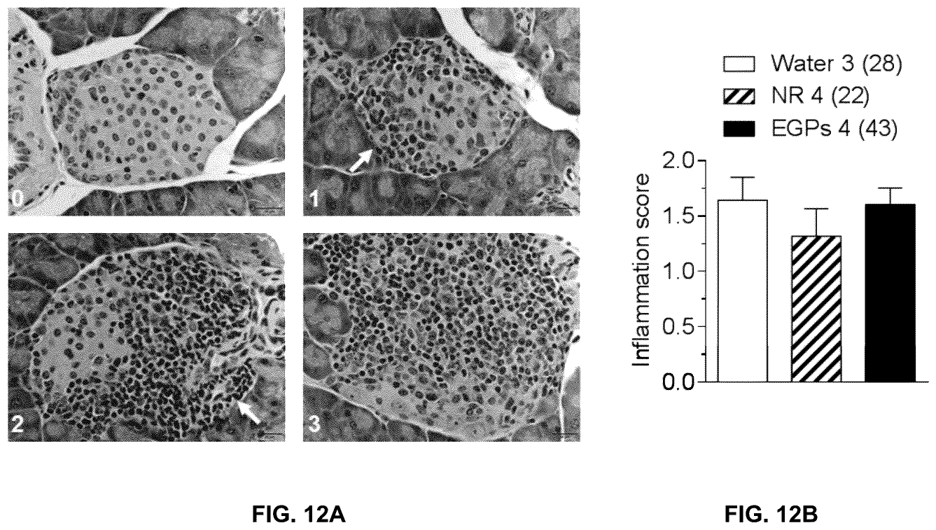

Since the mechanism of T1D in NOD is manifested as immune dysregulation and immune cells infiltrating into pancreas [Delovitch TL, et al. Immunity, 1997 7:727-38], the inflammation in β-islets was firstly evaluated by histopathology, but no significant differences were detected (FIG. 12). The negative finding was probably because the treatment started between week 6-8 while insulitis in NOD mouse started at week 4-6, and EGPs might have minimal effect on the already infiltrated immune cells. The subtle difference would be beyond the sensitivity of the semi-quantitative histopathology. Therefore, the pancreatic immune infiltrates of the non-diabetic NOD females after dosing for 4 weeks were dissociated and evaluated by flow cytometry. EGPs decreased the total immune infiltrates in the pancreas, and decreased the number of macrophages, CD8⁺ T cells and B cells by 50% when comparing to water and NR controls with significant changes observed in B cells between NR and EGPs. However, there were no differences among the groups in the CD4⁺ T infiltrate number (FIG. 3G).

### EGPs Produce Protective Effects in NOD Males

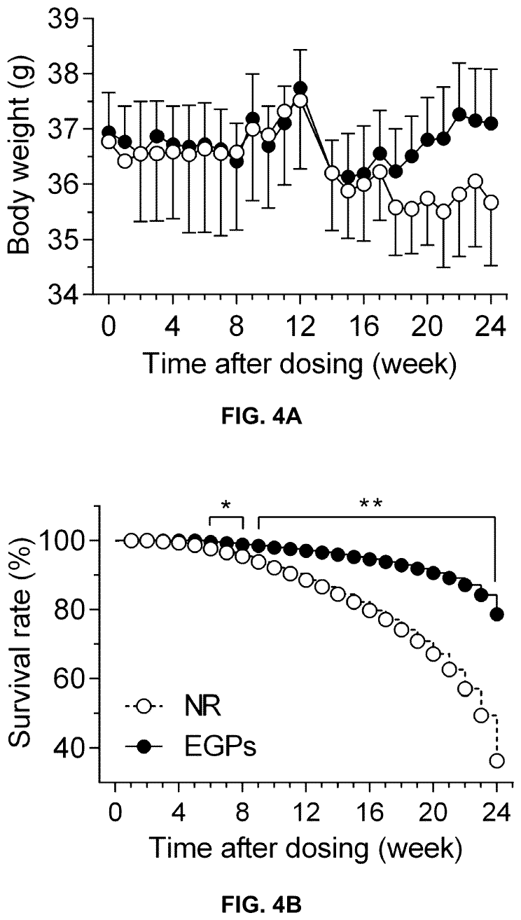

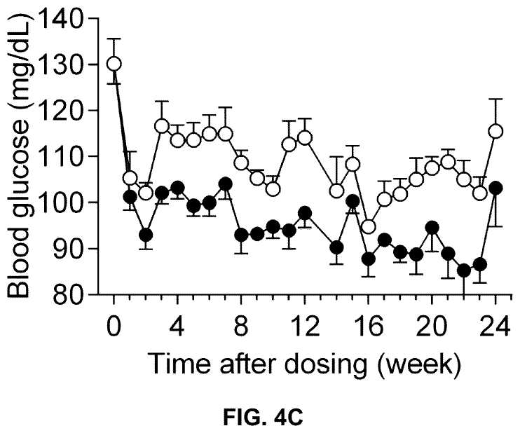

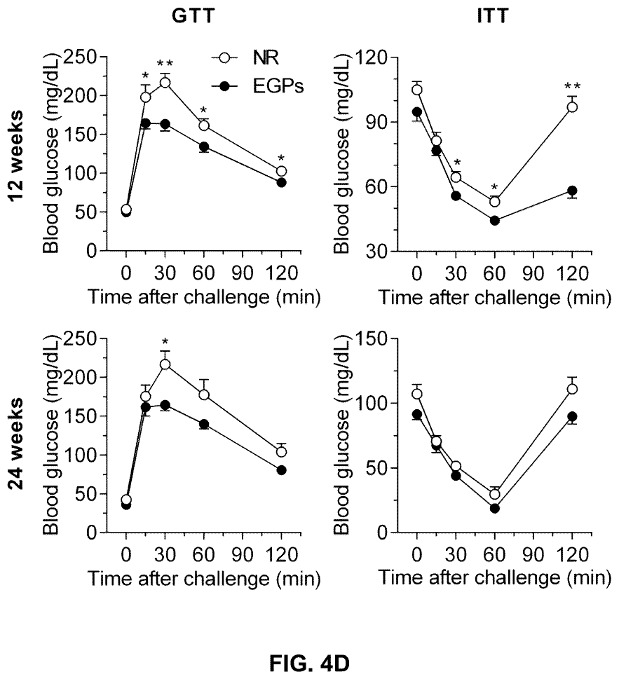

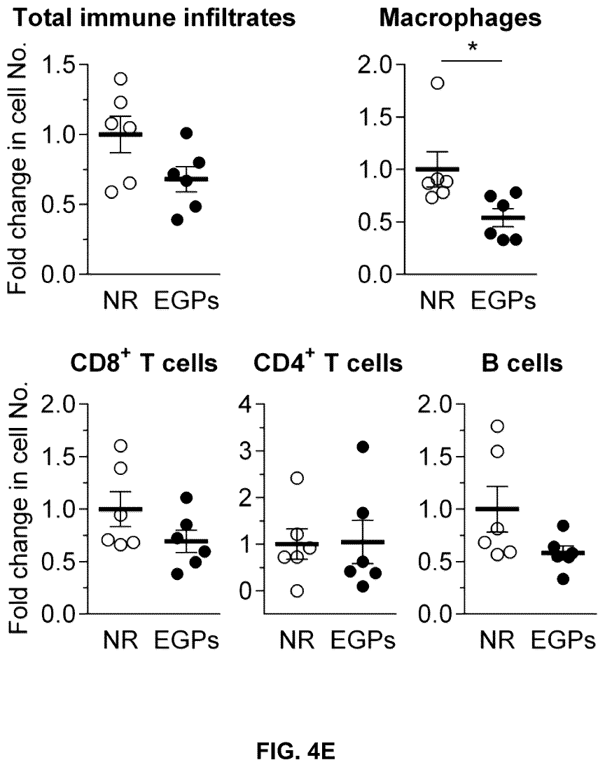

Non-diabetic NOD males were randomized into two groups (age matched) and dosed with NR or EGPs. NOD males have later T1D onset and lower incidence compared to females, so they were kept longer than 16 weeks. EGP-treated mice maintained the BW, whereas NR-treated mice started to show a decrease in BW starting at week 18 post treatment (FIG. 4A), suggesting that chronic oral intake of EGPs might have generated protective effects in the autoimmune male NOD mice. This speculation was further proved by the survival rate: EGPs increased the survival rate of NOD males by 40% compared to NR control (FIG. 4B), but none of the morbidities was due to hyperglycemia. Due to the autoreactive immunity, NOD mice develop many types of organ-specific autoimmune diseases in addition to T1D. Oral consumption of EGPs might delay or inhibit these autoimmune processes. To verify it, the pancreas was selected as the representative organ, and the BGL and pancreatic immune infiltrates in the NOD males were measured. Indeed, EGPs decreased and maintained the non-fasting BGL at normal level (vs. NR), and significantly increased the glucose metabolism and insulin sensitivity during GTT and ITT, respectively (FIG. 4C-D). Furthermore, fewer immune cells infiltrated into the pancreas, and fewer macrophages, CD8⁺ T and B infiltrates within pancreas were detected when compared to NR (FIG. 4E), and this was highly consistent with NOD females.

### EGPs Alter the Immunity in NOD Mice

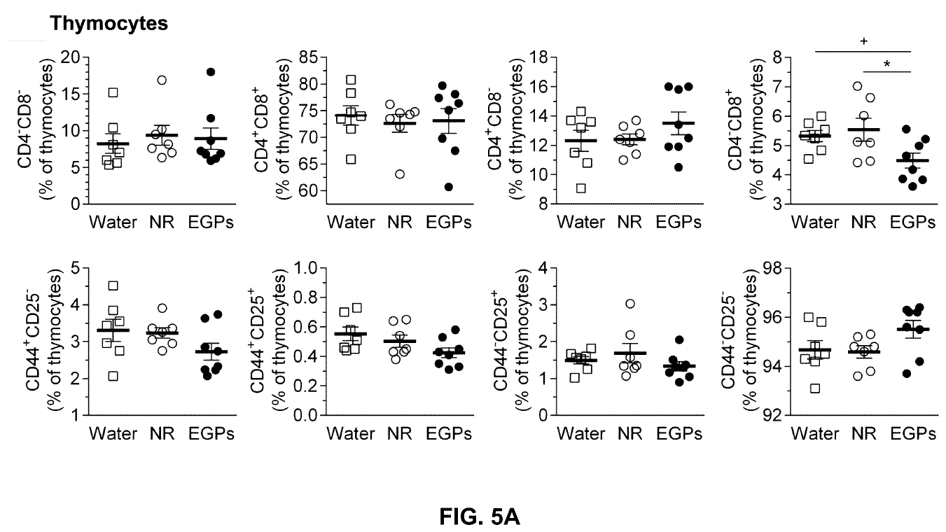

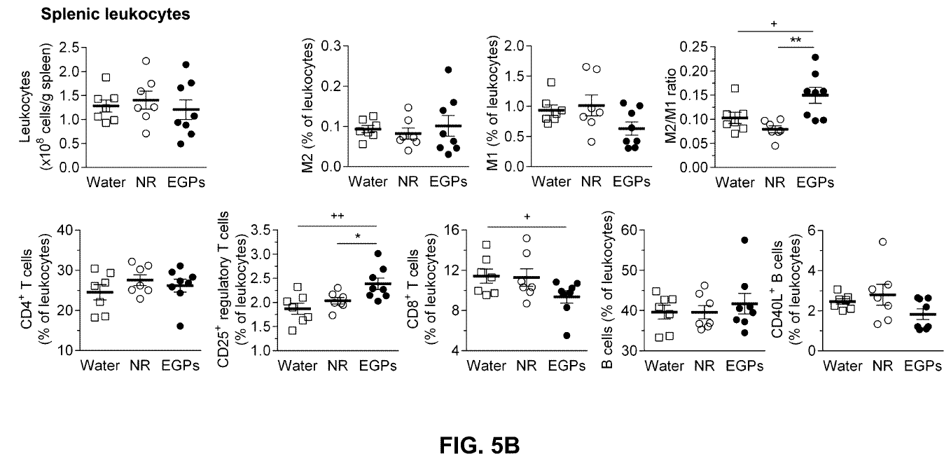

By studying the effects of EGPs on T1D using two models (i.e., MLD-STZ-induced, NOD mouse), it was reasonable to hypothesize that EGPs exerted the protective effect against T1D through regulating the immunity. Therefore, the following section was to understand how the immunity, especially the aspects relevant to T1D progression, was affected by EGPs. After being treated for 4 weeks, non-diabetic NOD females were euthanized and the immune cell populations in primary and secondary lymphoid organs were studied. In the thymus, CD4CD8 and CD25CD44 thymocytes were studied (FIG. 5A). EGPs decreased the CD8 single positive cells but not the others. In the spleen, the percentage of M2 (anti-inflammatory) was slightly increased while % M1 (pro-inflammatory) was decreased by EGPs, leading to a significant increase of M2/M1 ratio (FIG. 5B, upper panel). These results revealed the anti-inflammatory feature of EGPs. In addition, the percent CD4⁺CD25⁺ regulatory T cells was increased even though the total CD4⁺ T cells were unaffected, and % CD8⁺ T cells was decreased by EGPs (FIG. 5B, lower panel). For the splenic B cells, EGPs decreased the CD40 ligand positive populations (B220⁺CD40L⁺, the P=0.05, FIG. 5B lower panel).

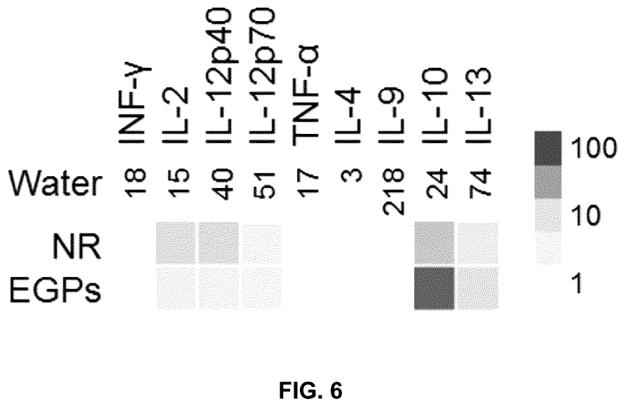

The profiles of serum cytokines/chemokines were examined. Comparing to background (water), NR and EGPs consumptions had an enhancing effect on most cytokines/chemokines including G-CSF, GM-CSF, IL-1β, IL-2, IL-6, IL-7, IL-10, IL-12p40, IL-12p70, IL-13, IL-15, IL-17, INF-γ, LIF, M-CSF, MCP-1, MIG, MIP-2, RANTES and VEGF (Table 3). Key T1D regulators were separately graphed in FIG. 6. EGPs had little effects on the most important Th1 (INF-γ) and Th2 (IL-4) markers for pancreatic β-islets destruction and protection in NOD mice, respectively. For the other pro-inflammatory cytokines (i.e., IL-2, IL-12p40, IL-12p70, TNF-α), EGPs significantly increased IL-2 and IL-12p70, numerically increased IL-12p40, and had no effects on TNF-a when compared to water. EGPs significantly decreased IL-2 and IL-12p40, and had no effect on either IL-12p70 or TNF-α when compared to NR. All the other T1D relevant anti-inflammatory cytokines (i.e., IL-9, IL-10, IL-13) were either significantly or numerically increased by EGPs when compared to water and NR. Strikingly, IL-10, another vital Th2 marker other than IL-4, was increased 86-and 3-folds by EGPs compared to water and NR, respectively. Taken together, EGPs shifted the cytokine/chemokine profile toward anti-inflammation despite the omnibus activation effect, which was highly in accordance with the M2 biased polarization in the spleen.

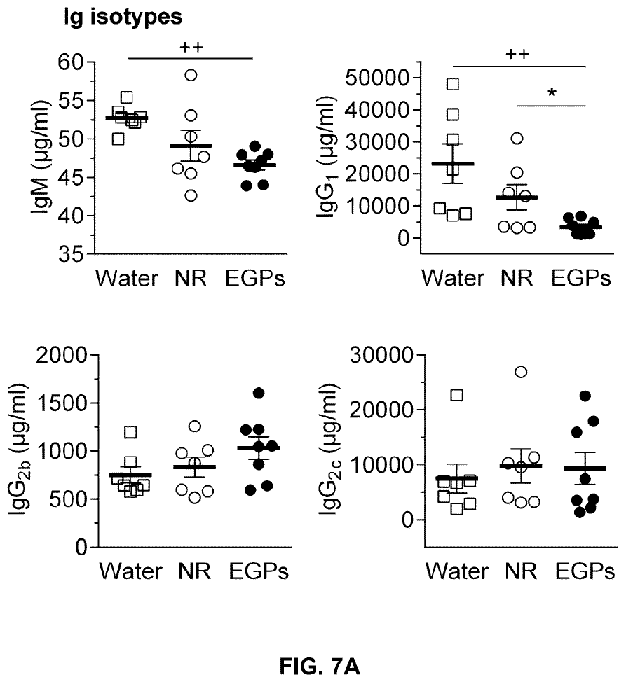

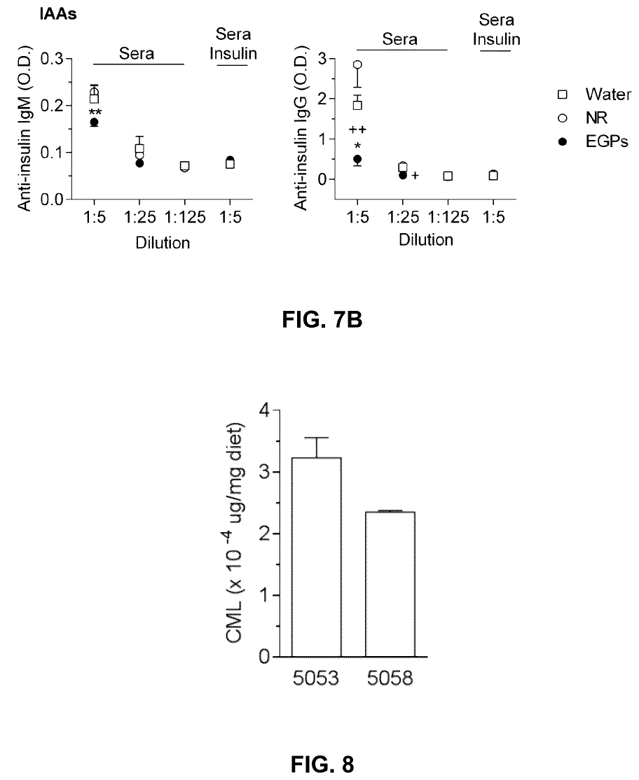

The serum levels of IgM, IgG₁, IgG_{2b} and IgG_{2c} were measured. The baseline levels of the 4 Ig isotypes in the water group was IgG₁>IgG_{2c}>IgG_{2b}>IgM (FIG. 7A). EGPs significantly decreased IgM and IgG1 when compared to water; and significantly decreased IgG1 when compared to NR. In the autoimmune prone NOD mice, autoantibodies were IgG predominant, and both IgG and IgM classes could recognize self-antigens known to induce diabetes, such as insulin [Quintana FJ, et al. J Autoimmun, 2001 17:191-7]. When IAA titers were measured, EGPs significantly decreased anti-insulin IgM and IgG when compared to water and NR (FIG. 7B).

### Discussion

Overall, this study provides support for possible nutraceutical application of WPI-derived EGPs for patients with insulitis and T1D. As data from the NOD females suggested, oral consumption of EGPs delayed the T1D onset and decreased the T1D incidence over 50%. Studies in both NOD males and females showed decreased and stabilized non-fasting BGLs, increased glucose metabolism during GTT and increased insulin sensitivity during ITT, which were accompanied with reduced pancreatic immune infiltrates. However, in another T1D model, the STZ-induced β-cell destruction in C57BL/6 females that was much less immune-dependent, the protective effect of EGPs against T1D diminished. The seemingly contradictory results from two T1D models suggested that EGPs were likely to exert their effect through modulating the immunity.

When the immune changes in the non-diabetic NOD mice were evaluated to reveal the underlying mechanisms, EGPs were found to affect the immune system in the following three aspects. First, EGPs decreased the CD8⁺ T cells in NOD mice. Since CD8⁺ T cells were believed to be the main effector cells to attack β-islets [Mathis D, et al. Nature, 2001 414:792-8], a decrease of CD8 single positive cells in the thymus and CD8⁺ T cells in the periphery could be one reason how EGPs protected NOD mice from T1D. In the thymus, EGPs decreased the CD8 single positive thymocytes without affecting the other CD4CD8 and CD44CD25 subpopulations, which suggested that EGPs might affect the positive or negative thymic selection and required further studies.

Secondly, EGPs were anti-inflammatory for NOD mice. On the one hand, splenic M2/M1 ratio was increased by EGPs, suggesting a regulation of macrophage polarization towards anti-inflammatory M2. It was reported that injection of M2 macrophages to the prediabetic NOD recipients protected >80% of treated mice against T1D for at least 3 months [Parsa R, et al. Diabetes, 2012 61:2881-92]. On the other hand, serum IL-10 was up-regulated 86-and 3-folds by EGPs compared to water and NR, respectively. Importantly, IL-10-deficient mice experienced severe T1D [Tian J, et al. J Immunol, 2001 167:1081-9]. In our previous studies, IL-10 was also identified as one of the most up-regulated cytokines/chemokines when EGPs was applied to human macrophages (PMA-differentiated-U937 cells), and peritoneal macrophages from C57BL/6 females [Chen Y, et al. Mol Nutr Food Res, 2018 62:e1700641]. It was possible that M2 polarized macrophages directly secreted IL-10 or activated other IL-10 secreting cells, leading to its up-regulation in the circulation. Besides M2 macrophages, other cell types were reported to produce IL-10, such as CD19hiCD1dhiCD5⁺ (mouse) [Yanaba K, et al. Immunity, 2008 28:639-50] and CD24hiCD27⁺ (human) [Iwata Y, et al. Blood, 2011 117:530-41] regulatory B cells (B10) and regulatory T cells. The IL-10-secreting CD4⁺ T cells were CD4⁺CD25⁺ and transcription factor forkhead box protein P3 (Foxp3)-independent [Fujio K, et al. Adv Immunol, 2010 105:99-130], and this specific population was up-regulated in the spleen upon EGP treatment.

The third aspect addressed the autoreactivity. It was reported that CD40 ligand expression on B cells could initiate insulitis and antigen-specific T cell responses [Balasa B, et al. J Immunol, 1997 159:4620-7]. When B cells were activated by a combination of CD40 ligand and IL-4 ex vivo, an enhanced insulin-processing and presentation of B: 12-20 epitope to 8F10 CD4⁺ T cells was observed. These T cells helped anti-insulin B cells to produce IAAs [Wan X, et al. J Exp Med, 2016 213:967-78]. Therefore, our observation that EGPs decreased the CD40L⁺ B cells might lead to a decreased autoreactivity. Indeed, when IAAs were quantitated, the level of anti-insulin IgG, the predominant anti-insulin Ig class in NOD mice, was dramatically decreased by EGPs.

### Conclusions

In summary, oral intake of WPI-derived EGPs delayed the T1D onset in NOD females through modulating the immunity. EGP consumption reduced CD8⁺ T cells and IAAs, and increased IL-10, CD4+CD25+regulatory T cells and the anti-inflammatory responses by shifting M2/M1 balance toward M2. These data strongly suggested the applicable potential of EGPs as a nutraceutical for individuals with insulitis and T1D. Future studies would focus on the molecular mechanisms how the EGP component(s) affect the thymic positive and/or negative selection, macrophage polarization, and IAA production. Besides T1D, EGPs might be beneficial for other autoimmune diseases as indicated by the data of NOD males. Expanded studies with focuses on other autoimmune diseases might enlarge the application of EGPs as a nutraceutical.

TABLE 1
Histopathological assessment of β-islets

| | |
|---|---|
| Score | Pathological change of β-islets |

Inflammation

| | |
|---|---|
| 0 | Unaffected |
| 1 | Minimal affected. Only the periphery of the islet affected |
| 2 | Inflammation present through the islet while the islet is still |
| | recognizable |
| 3 | Islet destroyed |

Vacuolation

| | |
|---|---|
| 0 | No vacuole in the islet cells |
| 1 | The islet cells have only small vacuoles, or one cell has many |
| | small vacuoles |
| 2 | Mix of small vacuoles and large single vacuole per cell within |
| | the islets |
| 3 | Predominantly large single vacuole in the islet cells |

TABLE 2
Organ/Tissue weight of the non-diabetic NOD females after dosing for 4 weeks.

| | Organ/Tissue weight (g) | | | | | |
|---|---|---|---|---|---|---|
| Group | Spleen | Thymus | Liver | Kidney | Lung | Heart |
| Water | 0.067 ± 0.002 | 0.063 ± 0.003 | 0.996 ± 0.031 | 0.248 ± 0.009 | 0.238 ± 0.022 | 0.125 ± 0.006 |
| NR | 0.070 ± 0.002 | 0.056 ± 0.003 | 1.116 ± 0.087 | 0.285 ± 0.028 | 0.300 ± 0.028 | 0.129 ± 0.007 |
| EGPs | 0.074 ± 0.005 | 0.057 ± 0.002 | 0.971 ± 0.060 | 0.256 ± 0.011 | 0.239 ± 0.018 | 0.124 ± 0.005 |

All data are presented in mean ± SE; n = 7 for water and NR groups, and n = 8 for EGP group. No significance was detected.

TABLE 3
Serum cytokine/chemokine levels.

| | | Treatment | |
|---|---|---|---|
| Cytokine (pg/ml) | Water (EGPs/Water) | NR (EGPs/NR) | EGPs |
| Eotaxin | 1031.36 ± 116.07 (1.20) | 890.17 ± 125.03 (1.39*) | 1242.36 ± 142.98 |
| G-CSF | 185.68 ± 18.87 (1.64⁺) | 202.89 ± 27.04 (1.50) | 304.22 ± 60.45 |
| GM-CSF | 53.06 ± 14.63⁺ (3.55⁺) | 170.51 ± 37.28 (1.10) | 188.29 ± 47.43 |
| IL-1α | 461.87 ± 29.63⁺ (1.56) | 1060.25 ± 272.30 (0.68) | 718.27 ± 152.98 |
| IL-1β | 93.70 ± 0.00 (5.22) | 766.28 ± 233.47 (0.64) | 488.67 ± 157.05 |
| IL-2 | 15.25 ± 1.00⁺⁺ (5.58⁺) | 213.43 ± 49.67 (0.40*) | 85.14 ± 35.92 |
| IL-4 | 2.72 ± 0.40 (1.58) | 3.27 ± 0.56 (1.32) | 4.31 ± 0.78 |
| IL-6 | 5.13 ± 1.05 (6.88⁺) | 10.69 ± 3.34 (3.30*) | 35.32 ± 11.56 |
| IL-7 | 32.80 ± 16.58⁺ (272.02⁺) | 6950.60 ± 3632.89 (1.28) | 8922.69 ± 3927.65 |
| IL-9 | 218.36 ± 26.77⁺ (1.37) | 417.34 ± 99.08 (0.72) | 299.23 ± 57.33 |
| IL-10 | 24.24 ± 9.44⁺ (85.85⁺) | 667.98 ± 193.46 (3.12) | 2080.98 ± 862.60 |
| IL-12p40 | 40.50 ± 6.67⁺ (5.46) | 593.84 ± 177.29 (0.37*) | 221.20 ± 95.81 |
| IL-12p70 | 51.24 ± 14.29⁺ (4.90⁺) | 261.75 ± 71.51 (0.96) | 251.03 ± 97.92 |
| IL-13 | 73.52 ± 18.04⁺⁺ (11.29⁺⁺) | 566.84 ± 149.80 (1.46) | 829.85 ± 228.90 |
| IL-15 | 442.90 ± 122.85⁺⁺ (3.35⁺⁺) | 1825.50 ± 174.25 (0.81) | 1481.81 ± 265.67 |
| IL-17 | 2.93 ± 0.01 (9.69) | 9.24 ± 3.13 (3.08) | 28.43 ± 13.70 |
| INF-γ | 17.91 ± 2.63⁺ (2.49) | 61.57 ± 16.89 (0.73) | 44.67 ± 15.14 |
| IP-10 | 202.45 ± 26.55 (1.21) | 211.05 ± 10.68 (1.16) | 244.89 ± 36.26 |
| KC | 132.43 ± 12.81⁺ (1.04) | 205.85 ± 32.06 (0.67*) | 137.79 ± 14.54 |
| LIF | 16.93 ± 5.95⁺ (34.12⁺) | 430.92 ± 186.80 (1.34) | 577.57 ± 245.94 |
| LIX | 11721.38 ± 528.42 (1.01) | 10832.46 ± 479.05 (1.09) | 11858.24 ± 483.36 |
| M-CSF | 70.14 ± 10.21⁺ (12.43⁺) | 1069.15 ± 376.20 (0.82) | 872.07 ± 410.91 |
| MCP-1 | 85.07 ± 8.30⁺ (1.81⁺) | 279.34 ± 60.01 (0.55) | 154.27 ± 31.49 |
| MIG | 106.64 ± 13.91⁺ (12.38⁺) | 1468.21 ± 502.88 (0.90) | 1319.66 ± 504.49 |
| MIP-1α | 102.08 ± 23.40⁺⁺(1.74) | 295.99 ± 52.42 (0.60) | 177.85 ± 47.54 |
| MIP-1β | 77.32 ± 2.37⁺⁺(1.55) | 172.34 ± 17.83 (0.70) | 119.85 ± 29.85 |
| MIP-2 | 225.04 ± 32.50⁺⁺ (1.86⁺) | 514.01 ± 83.69 (0.82) | 419.20 ± 85.07 |
| RANTES | 12.64 ± 2.52⁺⁺ (2.84⁺) | 39.54 ± 7.28 (0.91) | 35.91 ± 9.56 |
| TNF-α | 17.22 ± 0.88⁺⁺ (2.00) | 59.68 ± 11.18(0.58) | 34.43 ± 9.00 |
| VEGF | 2.57 ± 0.45⁺⁺ (2.28⁺) | 15.27 ± 3.94 (0.38*) | 5.86 ± 1.46 |

Numbers in brackets indicate the fold changes either EGPs over water or EGPs over NR.
⁺P < 0.05,
⁺⁺P < 0.01 NR vs water (out of parenthesis), EGPs vs water (in parenthesis);
*P < 0.05 EGPs vs NR.

### Example 2: Chronic Oral Exposure to Glycated Whey Proteins Increases Survival of Aged Male NOD Mice With Autoimmune Prostatitis by Regulating Gut Microbiome and Anti-Inflammatory Responses

### Materials and Methods

### EGP Preparation

The whey protein derived EGPs were prepared as described before (Chen, Y, et al, Mol Nutr Food Res, 2018, 62). In brief, whey protein isolate (WPI, Fonterra (USA) Inc, Rosemont, IL) and glucose (Sigma-Aldrich, St. Louis, MO) were dissolved in distilled water at the molar ratio of free amino groups and reducing ends at 1:2. The solution was freeze-dried and incubated in a desiccator containing a saturated aqueous Mg (NO₃)₂ solution at 55° C. for 8 h. LC-MS showed that all the whey proteins were modified by glucose, and the reaction had not progressed to later stages (Chen, Y et al, J Funct Foods, 2019, 56:171-181).

### Mouse Model of Autoimmune Prostatitis and the Treatment Regimen

NOD males were obtained from Taconic Biosciences (Rensselaer, NY), and housed in the Coverdell Vivarium at the University of Georgia (UGA). The room was maintained on a 12-h dark/light cycle at 21-24° C. with 20-60% relative humidity. Mice had access to food (Diet 5053, PicoLab® Rodent Diet 20, LabDiet, MO) and filtered tap water ad libitum. Blood glucose levels were measured from sampling caudal venous tail blood with a Bayer's CONTOUR blood glucose meter (Bayer Health Care LLC, Mishawaka, IN). Diabetic mice were identified as those with a blood glucose level>200 mg/dl in two consecutive weeks. At the study termination, the mice were euthanized by CO₂ inhalation followed by cervical dislocation. The use of the animals was approved by UGA Institutional Animal Care and Use Committee (IACUC).

Age-matched non-diabetic NOD males (approximately 4-month-old) were randomly separated into 2 groups and gavaged daily with NR and EGPs at 600 mg/kg body weight (BW) for up to 6 months. This dose was physiologically relevant as discussed previously (Chen, Y, et al, Mol Nutr Food Res, 2018, 62), and EGPs at this dose protected NOD mice from developing T1D (Chen, Y et al, J Funct Foods, 2019, 56:171-181). Mice were euthanized at month 3 and 6 following the first dosing. Aged NOD males have decreased incidences of diabetes, and none of them developed T1D during the experimental period. However, for the survival study, some mice had to be euthanized during the study when the thresholds of humane endpoints were reached due to other autoimmune diseases and cancer. They were recorded as moribund events.

### Histological Assessment of the Prostatic Inflammation

The urogenital organs without seminal vesicles and partial anterior prostates were dissected and placed in 10% buffered formalin. Longitudinal cuts at every 1-2 mm were conducted, and the sections were processed for hematoxylin and eosin (H&E) staining by the Histology Laboratory (College of Veterinary Medicine, UGA). The inflammation in 4 prostatic lobes (dorsal, lateral anterior and ventral) was scored by a board-certified veterinary pathologist. The scoring system was described in detail by Haverkamp et al.: 0, no inflammation; 1, mild inflammation; 2, moderate inflammation; 3, severe inflammation (Haverkamp, JM, et al, Prostate, 2011, 71:1139-1150). The mouse prostatic lobes were identified according to the histological guidelines introduced by Oliveira et al (Oliveira, DS, et al, Bosn J Basic Med Sci, 2016, 16:8-13).

### Flow Cytometric Analysis

The preparation of single-cell suspensions were similar to the procedures described before 9. A section was dissected from the anterior prostate (AP) and placed into PBS, and digested by 0.05 mg/ml collagenase (Sigma-Aldrich) and 5 U/ml DNase (Sigma-Aldrich) at 37° C. for 30-45 min. The mixture was centrifuged at 300 ×g at 4° C. for 8 min, and the pellet was resuspended in PBS and passed through a 40 μm-cell strainer with a fresh tube placed underneath to collect the single-cell suspension. Spleen was mashed using the frosted ends of two microscope slides, with the red blood cell lysed by adding ACK lysing buffer (Gibco by Life Technologies, Orand Island, NY) for 5 min.

Splenocytes and AP cells were stained for the following surface markers conjugated with fluorophores: CD3 (145-2C11, PerCP-Cy5.5, BD Pharmingen), CD4 (RM4-5, V450, BD Horizon), CD8 (53-6.7, APCH7, BD Pharmingen), F4/80 (BM8, FITC, eBioscience), CD80 (16-10A1, PE-CD594, BD Horizon), CD209 (LWC06, Alexa Fluor, Novus Biologicals), and B220 (RA3-6B2, FITC, eBioscience). After adding the antibodies, cells were incubated at 4° C. in the dark for 30 min. The cells were washed, and acquired on a Becton Dickinson LSRII Flow Cytometer (BD Biosciences). The flow cytometric data were analyzed using FlowJo v10 (FlowJo, LLC, Ashland OR). Leukocytes were characterized as CD4+ T cells (CD3+CD4+CD8−), CD8⁺ T cells (CD3+CD4−CD8+), macrophages (F4/80+), M1 (F4/80+CD80+CD209−), M2 (F4/80+CD80−CD209+), and B cells (B220+).

### Hematology

Hematology was conducted after 6-month treatment. A volume of approximately 200 μl venous blood sample was drawn from a tail nick, collected in tubes with K2EDTA (BD Microtainer, Franklin Lakes, NJ), and kept on ice. The hematology analyses with differentials were performed on the same day in the Veterinary Diagnostic Laboratory at the UGA Veterinary Teaching Hospital using the HESKA Element HT5 Veterinary Analyzer (Loveland, Co).

### Cytokine/Chemokine Quantitation

Following EGP treatment for 6 months, blood was collected from the orbital sinus of mice after being deeply anesthetized. The sera were separated and stored at −80° C. prior to use. Thirty-one cytokines/chemokines in the sera were detected using the MILLIPLEX MAP Mouse Cytokine/Chemokine Kit (Millipore, Billerica, MA) following the manufacturer's instructions, and the data were collected and analysed using Bio-Plex Manager 6.1.1. The working rang was 12.8-40,000 pg/ml for IL-13, and 3.2-10,000 pg/ml for the rest with IL-15 being out of range.

16S rRNA Gene Sequencing and Bioinformatics Analysis

The feces were collected from individual mice 6 months after initial EGP dosing, transferred to the 500 μL Eppendorf tubes and kept in a −80° C. freezer. DNA was extracted using QIAamp DNA stool mini kits (Qiagen, Valencia, CA) following manufacturer protocols. For library preparation, DNA was normalized to 20 ng/μL at Georgia Genomic Facility (GGF) and the V3-V4 region of 16S rRNA was targeted using locus-specific primers for the first round of PCR. Illumina-specific iTru_R1_5′_fusion and iTru_R2_5′_fusion Read 1 and Read 2 sequencing primers (forward: S-D-Bact-0564-a-S-15, and reverse: SD-Bact-0785-a-A-21) were used with 20 internal tags (8 forward fusion primers and 12 reverse fusion primers) ranging from 5 nucleotides (NT) to 8 NTs long (Glenn, TC, et al, bioRxiv, 2016, 049114). The PCR mix was from Kapa Biosystems, Inc. (Boston, MA). Next, the PCR amplicon aliquot was purified and quantified using AMPure beads. The second round PCR was run using Illumina i5 and i7 primers, and sequencing was done on Illumina Miseq (Illumina Inc., San Diego, US). Bioinformatics analysis was performed as previously described (Lefever, DE, et al, Toxicol Appl Pharmacol, 2016, 304:48-58). The subsequent analysis was performed on Quantitative Insights IntoMicrobial Ecology (QIIME) version 1.9.0, a pipeline that worked with high throughput 16S rRNA sequencing data (Lefever, DE, et al, Toxicol Appl Pharmacol, 2016, 304:48-58). Linear discriminant analysis (LDA) effect size (LEfSe) analysis was used to identify significantly different taxa following the conditions on the Galaxy/Hutlab website. Features that had an LDA score>2 were plotted.

### Statistical Analysis

The survival curve was compared using Gehan-Breslow-Wilcoxon test, and all the immune parameters were tested using Student's t-test on GraphPad Prism 6 (GraphPad Software, San Diego, CA). Nonparametric t-test was used to test the statistical significance for a diversity, and Analysis of Similarities (ANOSIM) for β diversity. Correlational analysis was assessed by XLSTAT (Addinsoft Inc., Long Island City, NY) using Spearman's correlation test.

### Results

### Chronic Exposure to EGPs Increases the Survival Rate and Moderately Reduces the Prostatic Inflammation

The survival rate of mice was recorded to indicate the overall effects of NR/EGPs. Chronic oral consumption of EGPs had an overall beneficial effect on the mice when compared to NR treatment: after 6 months of dosing, EGP treatment maintained the survival rate of the male NOD mice at ˜80%, while those dosed with NR only had a survival rate below 40%. No animals developed diabetes during the dosing period.

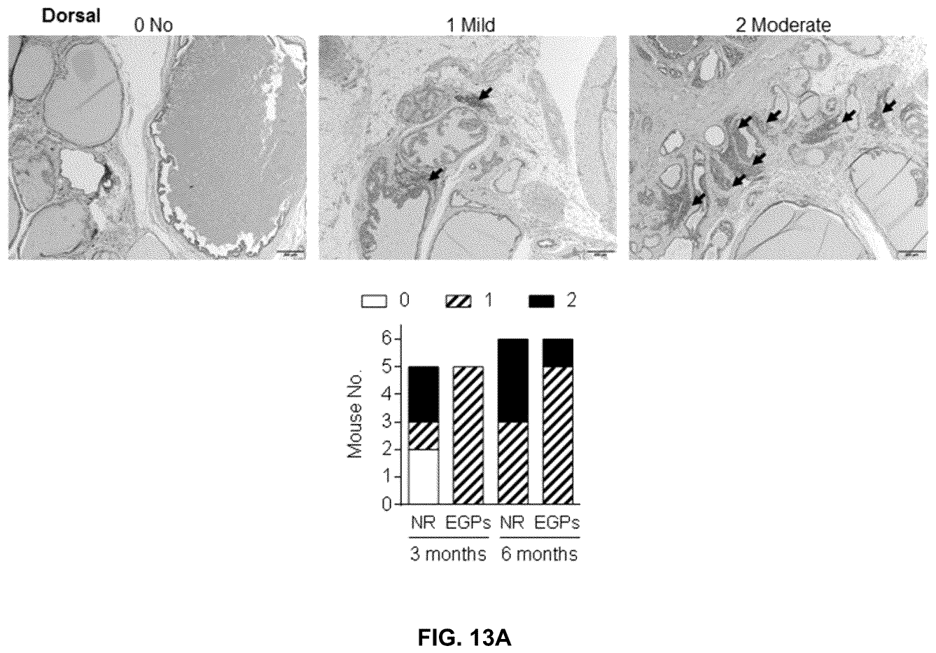

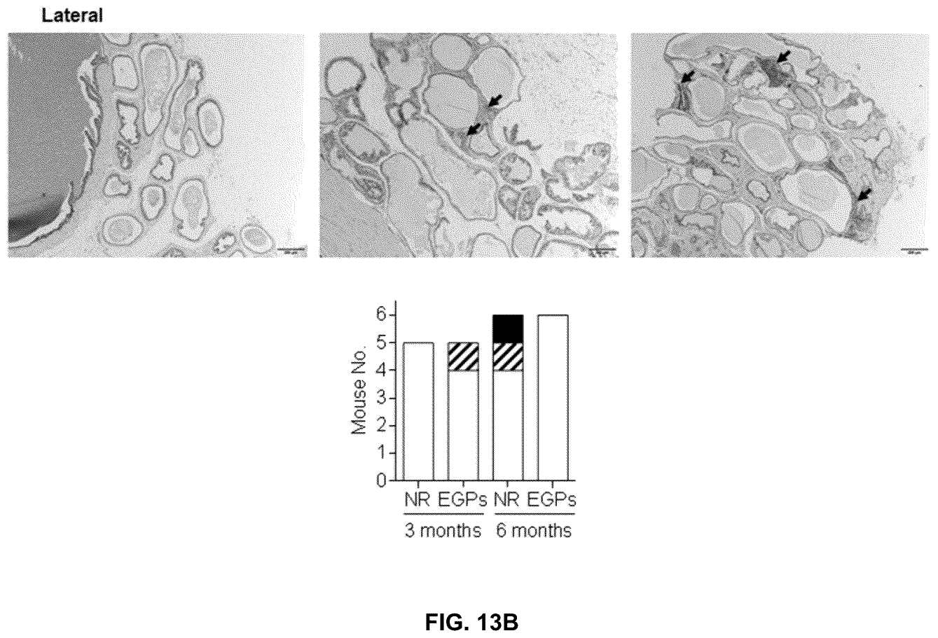

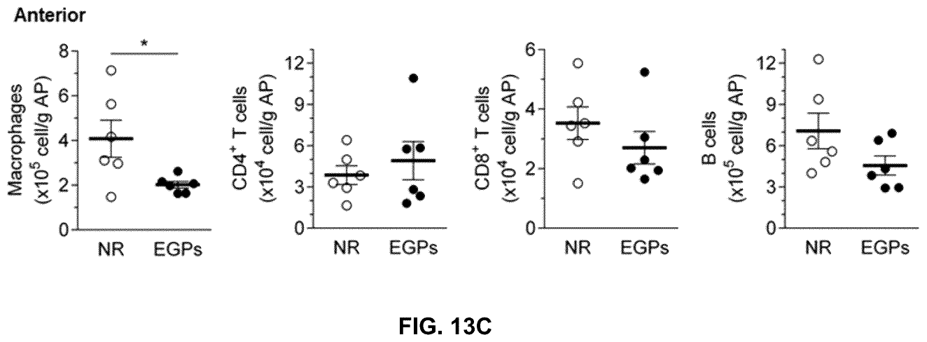

To evaluate the effect of EGPs on the intraprostatic inflammation, aging NOD males (>4 months) were euthanized after dosing for 3 or 6 months. Organs including AP were harvested, and none of them showed significant difference in weight between the NR and EGP treatment groups (Table 4). Longitudinal sections of the urogenital organs containing 4 prostatic lobes were H&E stained, and the inflammations associated with the 4 lobes were scored. Immune infiltration was detected in both dorsal and lateral prostates (FIG. 13 A&B black arrows). After 3 months of dosing, EGP treatment limited the inflammation in the dorsal prostate at the mild stage for all mice, while 2/6 mice treated with NR developed moderate inflammation. After 6 months of dosing, EGPs kept the inflammation in dorsal prostate mostly at the mild stage (5 mild and 1 moderate), whereas the NR group had half mice at the mild stage and the other half at the moderate stage (FIG. 13A last panel). For the lateral prostate (FIG. 13B), one animal had mild inflammation after 3 months of EGP treatment, which would most likely be due to the immune infiltration prior to the experiment, which could have occurred as early as 7 weeks-of-age 11. Prolonged treatment with EGPs for up to 6 months protected the lateral prostate from developing inflammation: no mice in the EGP group developed inflammation, while 1 mild and 1 moderate inflammatory incidence occurred in the NR group.

No inflammation was observed for anterior and ventral prostates using histopathological analysis. In previous studies, however, H&E staining was shown to be less sensitive than flow cytometric analysis (Chen, Y et al, J Funct Foods, 2019, 56:171-181), evidenced by the subtle differences in the immune infiltration of the pancreas being successfully detected using the latter, but not the former. Therefore, the infiltrating immune cells in the anterior prostate, after being treated for 6 months, were analyzed by flow cytometry (FIG. 13C). Macrophages, CD4+ T cells, CD8+ T cells and B cells were analyzed because they were frequently reported as being associated with inflamed prostates in NOD mice (Penna, G, et al, J Immunol, 2007, 179:1559-1567; Haverkamp, JM, et al, Prostate, 2011, 71:1139-1150). Among the analyzed cells, macrophages were significantly decreased by EGPs, while CD8+ T cells and B cells were numerically decreased. Taken together with the histopathological analysis, oral exposure to EGPs generated beneficial effects by controlling or slowing down the inflammatory progression in dorsal, lateral and anterior prostates. The inflammatory status within the ventral prostate had not been further studied due to technical issues (e.g., unable to clearly separate from other lobes). However, a previous study comparing the prostatic inflammation upon ovalbumin-specific CD8+ T cell transfer showed that the anterior, dorsal and ventral prostates responded similarly (Haverkamp, JM, et al, Prostate, 2011, 71:1139-1150).

### EGPs Alter the Systemic Immunity

The WBC number in the blood was slightly increased from 6.4 to 7.3 (×10³/μl) by EGP treatment for 6 months. Neutrophil and monocyte numbers were only numerically increased, while the eosinophil number was significantly increased. On the other hand, exposure to EGPs slightly decreased the number of lymphocytes, with more differences detected for the percentage (NR 48.3% vs. EGPs 40.8% of WBC, FIG. 14).

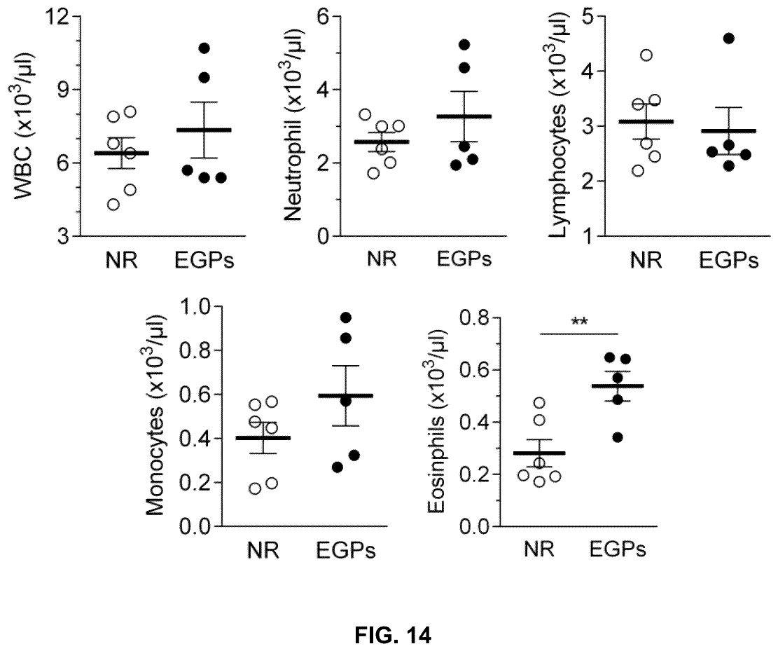

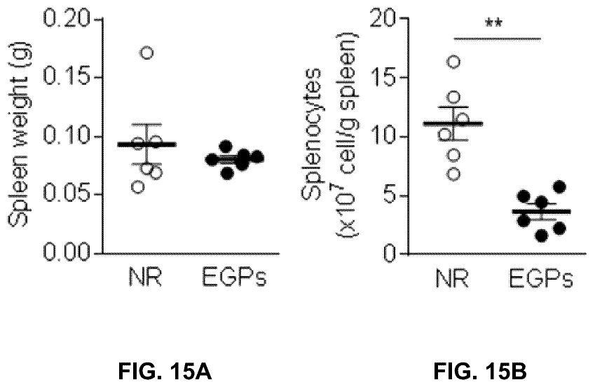

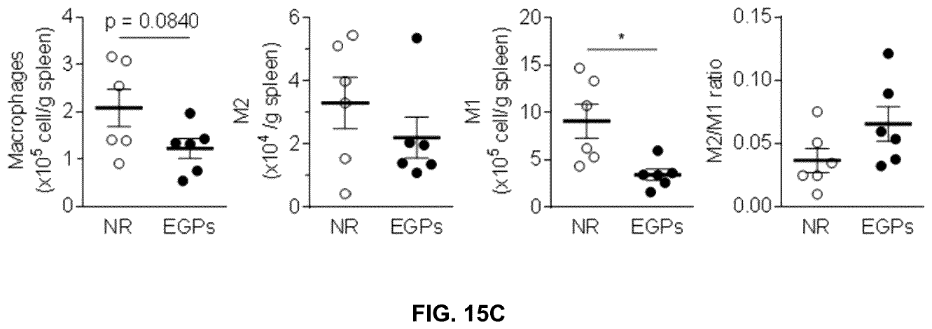

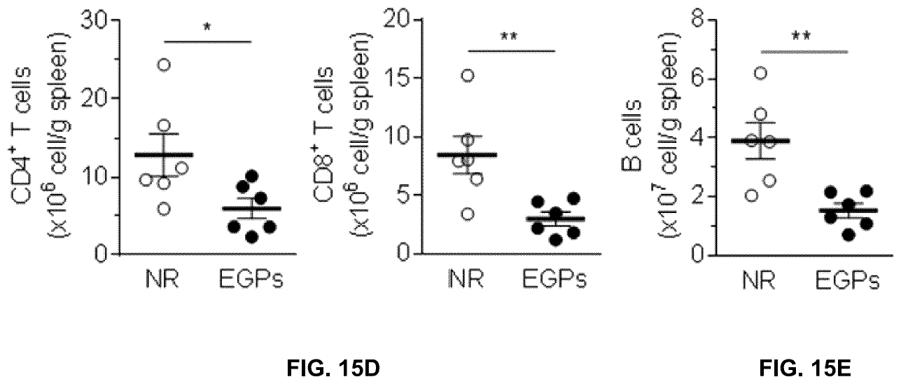

The spleen weights were not significantly different between the two groups (FIG. 15A), but total splenocytes and all the measured immune populations (i.e., macrophages, M1, M2, CD4+ T cells, CD8+ T cells, B cells) were decreased in the EGP group (FIG. 15B-E) with significant changes observed for total splenocytes, M1, CD4+ T cells, CD8+ T cells and B cells. However, the M2/M1 ratio was not significantly altered by EGP treatment (FIG. 15C).

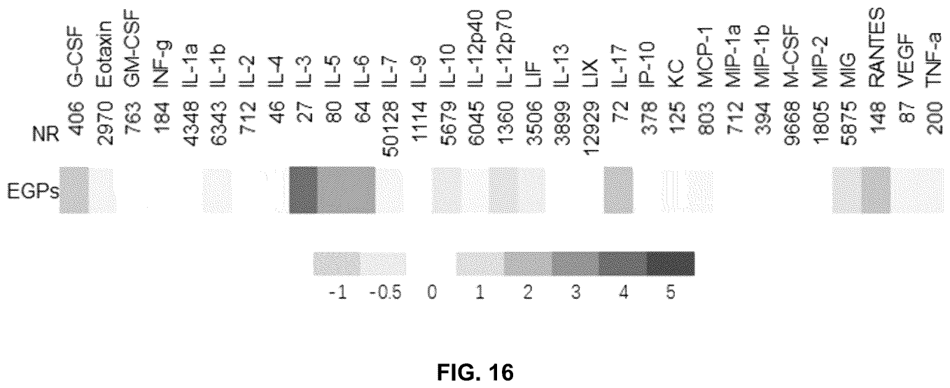

To further determine if EGPs generated anti-inflammatory effects, the cytokines/chemokines in sera were measured (FIG. 16). The up-regulated ones among the 31 cytokines/chemokines examined were IL-10, G-CSF, IL-3, IL-5, IL-6 and IL-17 with IL-10 showing statistically significant increases (5678.85 +979.60 (NR) versus 9644.43±764.86 (EGPs), p=0.0096, Table 5). IL-17 was increased 1.664 folds by EGPs, and the mean±SE was 72.34±15.24 (NR) versus 192.68±114.38 (EGPs, Table 5).

### EGPs Modulate Gut Microbiome

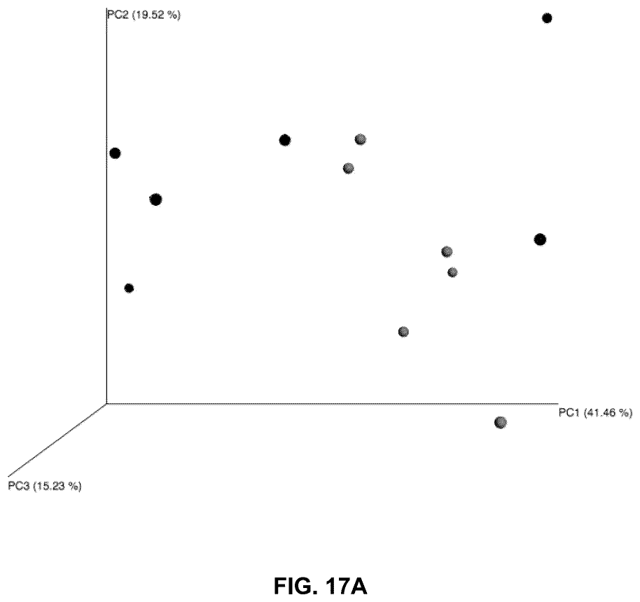

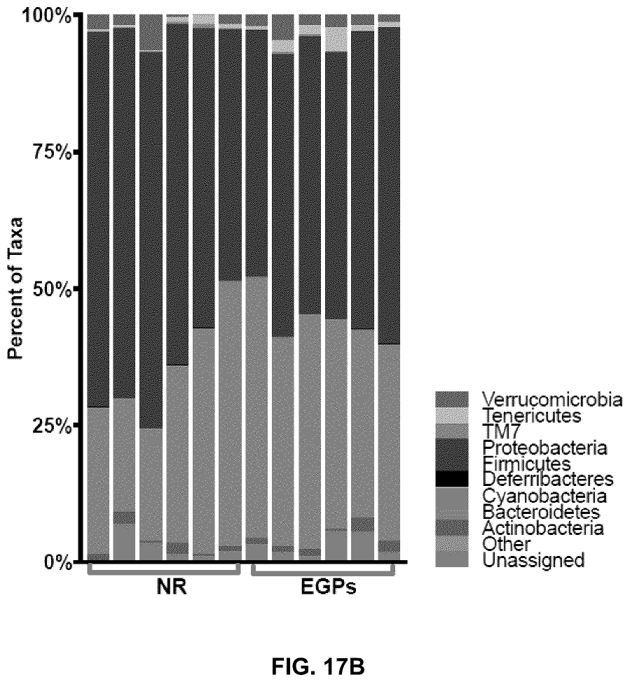

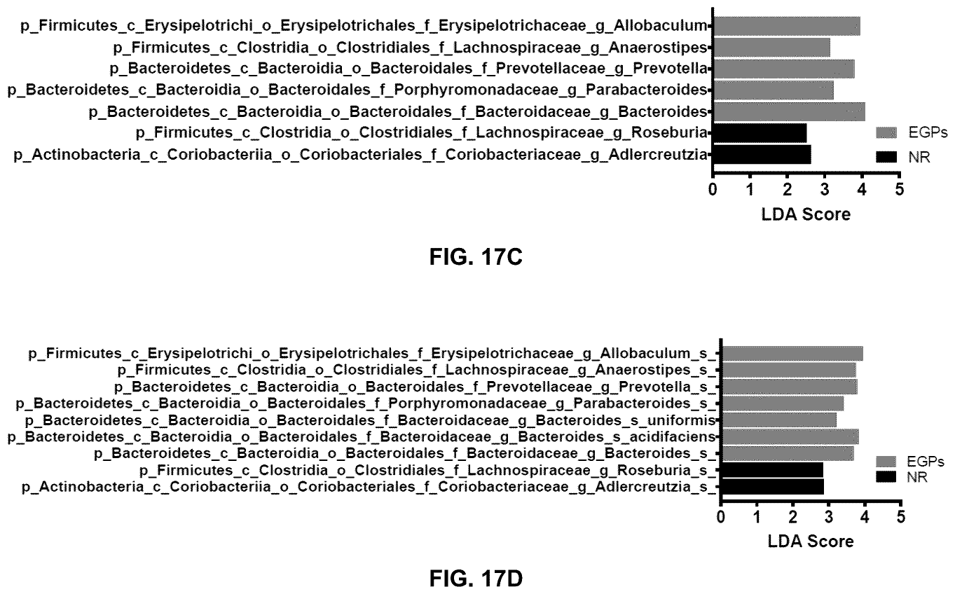

Correlations have been found between symptom scores and disease severity of CP/CPPS and the degree of dysbiosis in gut microbiomes (Arora, HC, et al, Ann Transl Med, 2017, 5:30). 16S rRNA sequencing was used to characterize the changes in the microbiome community composition. Principal coordinate analysis of the β diversity metrics showed that the gut bacterial communities in the NR and EGP groups were well separated when taking difference in abundance into account using weighted UniFrac (FIG. 17A). The weighted UniFrac result was supported by ANOSIM (p<0.05 with 999 permutation), which suggested the difference in the gut microbiome induced by EGP exposure was readily observable and well differentiated. However, EGP treatment did not show a clear pattern on the unweighted Unifrac, an index of β diversity indicating presence/absence (data not shown). Both the PD whole tree and chao1, indexes of α diversity that reflected the genetic diversity of the communities under study (Lozupone, CA, et al, FEMS Microbiol Rev, 2008, 32:557-578), were not significantly altered by EGP treatment.

The taxonomic profiles of the EGP treated versus the NR mice were then compared by assigning taxonomy to OTUs and subsequently splitting the OTU table into phylogenetic level. The relative abundances of taxonomy for each treatment at the phylum level are shown in FIG. 17B, with each color representing an individual bacterial phylum. Phylum Firmicutes represented 60.0% of the total bacteria in the NR group; while in EGP group, it represented 50.3% of the total taxa, which was significantly different from the NR group. Firmicutes/Bacteroides (F/B) ratio was decreased following EGP treatment (2.19±0.41 vs. 1.30±0.10); however, it did not reach the level of statistical significance. When the microbial taxa at the class level were compared, EGP treatment increased Erysipelotrichia, and decreased Coriobacteriia in terms of relative abundance. When the microbial taxa at the order level were compared, EGP treatment increased Erysipelotrichales, and decreased Coriobacteriales in terms of relative abundance. When the microbial taxa at the family level were compared, EGP treatment increased Porphyromonadaceae, Prevotellaceae, Erysipelotrichaceae and Bacteroidaceae, and decreased Coriobacteriaceae in terms of relative abundance. When the microbial taxa at the genus level were compared, EGP treatment increased Anaerostipes, Parabacteroides, Prevotella, Allobaculum and Bacteroides, and decreased Adlercreutzia and Roseburia in terms of relative abundance (FIG. 17C). When the microbial taxa at the species level were compared, EGP treatment increased Allobaculum s, Anaerostipes s, Prevotella s, uniformis, acidifaciens and Bacteroides s, and decreased Adlercreutzia s and Roseburia s in terms of relative abundance (FIG. 17D).

### Correlation Between Immunity and Gut Microbiome

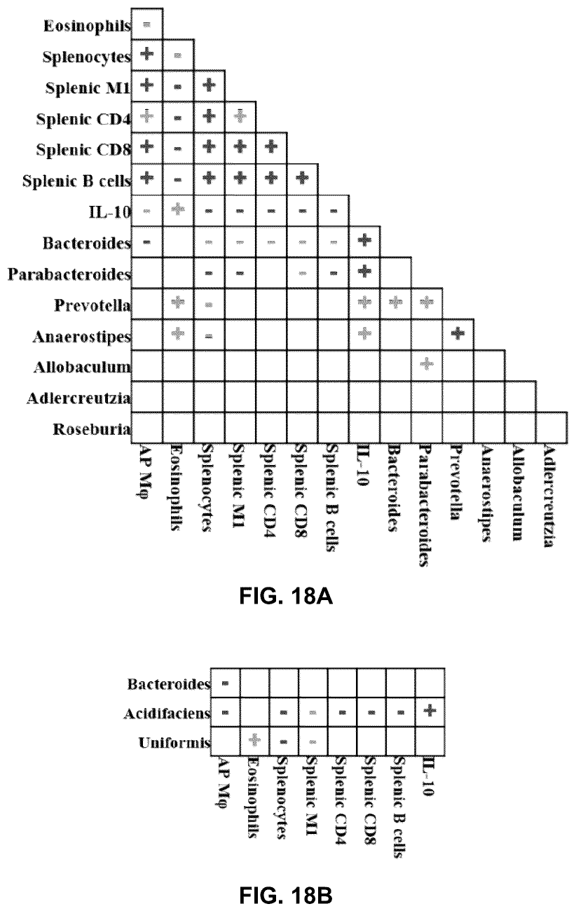

FIG. 18 illustrates the relationships between pairs of the variables that were significantly altered following EGP treatment. Spearman's correlation analysis revealed that the number of prostatic macrophages positively correlated with total splenocytes, splenic M1 macrophages, CD4+ T cells, CD8+ T cells and B cells, and negatively correlated with blood eosinophils, serum IL-10 and Bacteroides at the genus level (FIG. 18A). When Bacteroides at species levels were further analyzed, the number of prostatic macrophages negatively correlated with Bacteroides acidifaciens and another unidentified Bacteroides species (FIG. 18B). Blood eosinophils positively correlated with serum IL-10, Prevotella and Anaerostipe s at the genus level and Bacteroides uniformis at species level, and negatively correlated with total splenocytes, splenic M1 macrophages, CD4+ T cells, CD8+ T cells and B cells (FIG. 18A&B). The number of total splenocytes positively correlated with splenic M1 macrophages, CD4+ T cells, CD8+ T cells and B cells, and negatively correlated with serum IL-10 and Bacteroides, Parabacteroides, Prevotella and Anaerostipes at the genus level and Bacteroides uniformis and acidifaciens at species level (FIG. 18A&B). Splenic M1 macrophages positively correlated with splenic CD4+ T cells, CD8+ T cells and B cells, and negatively correlated with serum IL-10, Bacteroides and Parabacteroides at the genus level and Bacteroides uniformis and acidifaciens at species level (FIG. 18A&B). Splenic CD4+ T cells positively correlated with splenic CD8+ T cells and B cells, and negatively correlated with serum IL-10 and Bacteroides at the genus level and Bacteroides acidifaciens at species level (FIG. 18A&B). Bacteroides positively correlated with Prevotella at the genus level (FIG. 1A). Parabacteroides positively correlated with Prevotella and Allobaculum at the genus level (FIG. 18A). Prevotella positively correlated with Anaerostipes at the genus level (FIG. 18A). Taken together, the correlational analysis showed that all the significantly altered immune parameters were correlated to each other, and their further correlation with gut microbes suggested an overall anti-inflammatory feature.

### Discussion

In this work, the chronic effects of EGPs were studied in aged nondiabetic NOD males; the survival rate of these NOD mice was significantly increased by EGP treatment, which might be related to a systemic anti-inflammatory effect generated by EGPs. EGPs decreased total splenocytes, splenic M1 macrophages, CD430 T cells, CD8+ T cells and B cells (FIG. 15), while increasing the serum IL-10 level (FIG. 16). Upregulation of anti-inflammatory cytokine IL-10 by EGPs was previously observed in human macrophage culture (Chen, Y, et al, Mol Nutr Food Res, 2018, 62), as well as in the NOD females (Chen, Y et al, J Funct Foods, 2019, 56:171-181) and C57BL/6 males subcutaneously transplanted with TRAMP-C2 prostate cancer cells (Chen Y, et al, Mol Nutr Food Res, 2019, 63:e1800885). Interestingly, IL-10 has been shown to prevent aging-associated inflammation and insulin resistance (Dagdeviren, S, et al, FASEB J, 2017, 31:701-710), and aging-induced endothelial dysfunction (Kinzenbaw, DA, et al, Physiol Rep, 2013, 1:e00149). Moreover, IL-10 might mediate its anti-inflammatory effect by metabolically reprogramming macrophages (Ip, WKE, et al, Science, 2017, 356:513-519), and decreased IL-10 could result in enhanced mortality from Gram-negative sepsis (Noto, MJ, et al, Infect Immun, 2017, 85).

However, the Th2 response is also characterized by the production of IL-10, which may contribute to the immediate hypersensitivity response and eosinophil influx (Vykhovanets, EV, et al, Prostate Cancer Prostatic Dis, 2007, 10:15-29). It has been shown that certain Prevotella species promotes the differentiation of Th17 cells, which synergizes with eosinophils to accelerate multiple myeloma progression (Calcinotto, A, et al, Nat Commun, 2018, 9:4832). Further studies should be conducted to determine the effects of EGP-induced increases in blood eosinophils and IL-17.

Aged male NOD mice develop a wide spectrum of organ specific autoimmune diseases (Leiter, EH, ILAR Journal, 1993, 35:4-14), such as autoimmune prostatitis, that was characterized by leukocyte infiltration in the prostate gland (Penna, G, et al, J Immunol, 2007, 179:1559-1567). We have found that EGP treatment moderately decreased prostatic inflammation (FIG. 13). In addition, flow cytometric analysis suggested that the infiltrating immune cells, especially macrophages, in the anterior prostate were decreased by EGPs. The number of prostatic macrophages positively correlated with total splenocytes, splenic M1 macrophages, CD4+ T cells, CD8+ T cells and B cells, and negatively correlated with levels of serum IL-10 and gut Bacteroides (Genus). Specifically, the number of prostatic macrophages negatively correlated with Bacteroides acidifaciens and another unidentified Bacteroides species. Bacteroides uniformis, which was also increased by EGPs, could induce higher IL-10 production from Raw264.7 macrophages than other Bacteroides strains (Gauffin Cano, P, et al, J Urol, 2002, 167:753-756). However, the function of IL-10 in prostatitis is still controversial being debated. Although several cytokines and chemokines including IL-10 were significantly increased in seminal plasmas from patients with CP/CPPS (Miller, LJ, et al, J Urol, 2002, 167:753-756; Penna, G, et al, Eur Urol, 2007, 51:524-533) peripheral IL-10 was not significantly changed in these patients (Hu, C, et al, Sci Rep, 2016, 6:28608). Further studies by measuring cytokines in the seminal fluid following EGP treatment are warranted.

Only 3-10% protein-bound Amadori products were absorbed in the intestine after ingestion (Corzo-Martinez, M, et al, Int J Food Microbiol, 2012, 153:420-427). After eating a single meal containing fructoselysine, the human fecal secretion of fructoselysine was 2.6-5.6% (Erbersdobler, HF, et al, Mol Nutr Food Res, 2017, 61). Thus, it could be assumed that about 90% of orally consumed EGPs were decomposed by the gut microbes. In this study, EGP treatment altered the microbiome profile (β diversity) without decreasing the genetic diversity of the communities (α diversity). In contrast, advanced glycation end-products (AGEs), the homologous products of EGPs, were inflammatory and decreased the species richness and a diversity of gut microbiota in Sprague-Dawley rats (Qu, W, et al. Mol Nutr Food Res, 2017, 61) and C57BL/6 mice (Qu, W, et al, J Agric Food Chem, 2018, 66:8864-8875). For CP/CPPS patients, significantly decreased a diversity was observed comparing to controls who were asymptomatic or just had urinary tract symptoms (Shoskes, DA, et al, Eng, J Urol, 2016, 196:435-441). However, gut microorganism alteration in clustering but not diversity was reported for T1D patients (Mejia-Leon, ME, et al, Sci Rep, 2014, 4:3814).

Sequencing of 16S rRNA-encoding gene has identified Bacteroidetes and Firmicutes as the most abundant phyla in human gut microbiota (Blander, JM, et al, Nat Immunol, 2017, 18:851-860), and in fecal samples from NOD mice (Huang, G, et al, Toxicol Appl Pharmacol, 2017, 332:138-148). The F/B ratio has been extensively examined and correlated with various diseases. It has been reported that F/B ratio was higher in obese subjects and overweight subjects (Castaner, O, et al, Int J Endocrinol, 2018, 2018:4095789). In this study, F/B ratio was numerically decreased by EGPs, and these NOD mice had fewer prostatic immune infiltrates and higher survival rate. Similar phenomena were observed in our previous genistein studies, in which genistein prevented the hyperglycemia and numerically decreased F/B ratio in NOD mice (Huang, G, et al, Toxicol Appl Pharmacol, 2017, 332:138-148). However, a significant lower F/B ratio was also observed in patients with systemic lupus erythematosus (Hevia, A, et al, MBio, 2014, 5: e01548-01514), and these patients have higher IL-10 levels (Godsell, J, et al, Sci Rep, 2016, 6:34604). In contrast, it is also reported that aging-dependent decline of IL-10-producing B cells coincides with production of antinuclear antibodies (van der Geest, KSM, et al, Exp Gerontol, 2016, 75:24-29). Therefore, it is important determine if EGP consumption has any adverse effects in lupus patients.

EGP treatment increased Erysipelotrichia at the class level, Erysipelotrichales at the order level and Erysipelotrichaceae at the family level. The presence of a core microbial ecology including Erysipelotrichaceae is essential for a successful therapeutic fecal microbiota transplantation, which controls intestinal inflammation through inducing IL-10 secretion by immune cells (Burrello, C, et al, Nat Commun, 2018, 9:5184). Porphyromonadaceae at the family level and Parabacteroides at the genus level, which were also upregulated by EGPs, were positively correlated with IL-10 in healthy human stools (Bajaj, JS, et al. Hepatology, 2015, 62:1260-1271) and in mice (Cekanaviciute, E, et al, Proc Natl Acad Sci U S A, 2017, 114:10713-10718), respectively. In addition, EGPs significantly upregulated Allobaculum, Bacteroides, and Prevotella, and downregulated Roseburia at genus level. Other significantly regulated genera included an increased Anaerostipes and a decreased Adlercreutzia. The SCFA-producing bacteria Anaerostipes can improve insulin sensitivity by generating butyrate (Khan, S, et al, Chem Biol Interact, 2016, 254:124-134). On the other hand, genus Adlercreutzia was elevated in old vs. young wild type mice (Thevaranjan, N, et al, Cell Host Microbe, 2017, 21:455-466 e454). Overall, EGP-treated NOD males exhibited a healthier gut microbiome than the NR controls.

Among these significantly regulated genera, Bacteroides, which was predominantly contributed by Bacteroides acidifaciens (FIG. 18B), correlated with all the immune parameters except for the eosinophils (FIG. 18A). The expansion of gut Bacteroides acidifaciens was identified in mice with Atg7 conditional knockout in dendritic cells, which showed a lean phenotype with improved insulin resistance, lower body weight and fat mass (Yang, JY, et al, Mucosal Immunol, 2017, 10:104-116). In our previous study, decreased Prevotella and Anaerostipes were detected in hyperglycemic male CD-1 mice (multiple low dose streptozotocin-induced) following chronic 2,3,7,8-tetrachlorodibenzo-p-dioxin (TCDD) exposure, and correlated with liver weight, one of the indexes for liver toxicity (Lefever, DE, et al, Toxicol Appl Pharmacol, 2016, 304:48-58). In CP/CPPS patients, underrepresented Prevotella was detected comparing to controls (Shoskes, DA, et al, Eng, J Urol, 2016, 196:435-441). In this study, EGP-mediated increases in Prevotella and Anaerostipes correlated with changes in eosinophils and IL-10 positively, and splenocytes negatively (FIG. 18A). It should be noted that eosinophils can contribute to the inhibition of prostate cancer cell growth (Furbert-Harris, P, et al, Prostate, 2003, 57:165-175) and resolution of lung-allergic responses following repeated allergen challenge by producing IL-10 (Takeda, K, et al, J Allergy Clin Immunol, 2015, 135:451-460).

### Conclusions

In summary, this work demonstrated that chronic exposure to glycated whey protein alleviated autoimmune prostatitis and increased the survival rate in aged NOD male mice, which extended the potential application of EGPs from T1D (Chen, Y et al, J Funct Foods, 2019, 56:171-181) to a broader spectrum of autoimmune diseases. Anti-inflammation and modulated gut microbiome profiles were suggested to be the underlying mechanisms how EGPs produced their protective effects. This is the first animal study exploring the effects of EGPs on gut microbiome. Direct evidence has been presented that EGPs could modulate gut microbes in mice, and the data suggest that microbiome alterations correlate with immunity changes with gut microbiome upon EGP treatment.

TABLE 4
Organ weight in male NOD mice treated with NR or EGPs daily for 3 and 6 months
3 months

| | Spleen | Liver | AP | Kidney | GI |
|---|---|---|---|---|---|
| NR | 0.092 ± 0.006 | 1.901 ± 0.186 | 0.072 ± 0.018 | 0.585 ± 0.053 | 4.222 ± 0.395 |
| EGPs | 0.105 ± 0.007 | 1.983 ± 0.133 | 0.056 ± 0.004 | 0.557 ± 0.027 | 4.077 ± 0.291 |

| | Heart | Thymus | Lung | SV |
|---|---|---|---|---|
| NR | 0.191 ± 0.014 | 0.060 ± 0.015 | 0.268 ± 0.020 | 0.483 ± 0.075 |
| EGPs | 0.228 ± 0.14 | 0.082 ± 0.011 | 0.261 ± 0.016 | 0.445 ± 0.052 |

6 months

| | Spleen | Liver | AP | Kidney | GI |
|---|---|---|---|---|---|
| NR | 0.093 ± 0.017 | 1.740 ± 0.116 | 0.092 ± 0.013 | 0.556 ± 0.026 | 4.478 ± 0.336 |
| EGPs | 0.080 ± 0.003 | 1.731 ± 0.058 | 0.092 ± 0.007 | 0.552 ± 0.013 | 4.290 ± 0.208 |

| | Heart | Thymus | Lung | SV |
|---|---|---|---|---|
| NR | 0.203 ± 0.009 | 0.043 ± 0.004 | 0.238 ± 0.021 | 0.420 ± 0.021 |
| EGPs | 0.220 ± 0.008 | 0.033 ± 0.003 | 0.297 ± 0.038 | 0.451 ± 0.030 |

TABLE 5
Serum cytokine/chemokine levels.

| | Treatment | |
|---|---|---|
| Cytokine (pg/ml) | NR | EGPs |
| Eotaxin | 2970.25 ± 440.47 | 4301.66 ± 1083.52 |
| G-CSF | 406.45 ± 77.55 | 1034.87 ± 546.70 |
| GM-CSF | 763.53 ± 95.32 | 845.28 ± 55.68 |
| IL-1α | 4347.63 ± 831.92 | 4755.34 ± 339.93 |
| IL-1β | 6342.79 ± 2121.74 | 4371.32 ± 486.55 |
| IL-2 | 711.65 ± 121.77 | 876.99 ± 103.55 |
| IL-4 | 46.26 ± 21.18 | 58.33 ± 38.49 |
| IL-3 | 27.14 ± 6.10 | 136.06 ± 82.55 |
| IL-5 | 80.15 ± 16.36 | 279.45 ± 182.13 |
| IL-6 | 64.29 ± 16.06 | 221.92 ± 135.23 |
| IL-7 | 50128.06 ± 15380.78 | 70055.99 ± 18013.96 |
| IL-9 | 1114.03 ± 141.00 | 1292.20 ± 94.92 |
| IL-10 | 5678.85 ± 979.60 | 9644.43 ± 764.86* |
| IL-12p40 | 6045.27 ± 1753.36 | 4394.39 ± 466.23 |
| IL-12p70 | 1359.61 ± 245.54 | 2539.83 ± 759.38 |
| IL-13 | 3899.14 ± 718.32 | 4679.18 ± 506.46 |
| IL-17 | 72.34 ± 15.24 | 192.68 ± 114.37 |
| INF-γ | 184.46 ± 32.82 | 226.71 ± 27.06 |
| IP-10 | 378.38 ± 30.18 | 443.42 ± 64.93 |
| KC | 124.82 ± 13.78 | 160.68 ± 16.37 |
| LIF | 3506.53 ± 979.27 | 5456.64 ± 1285.81 |
| LIX | 12929.31 ± 452.20 | 13108.39 ± 729.31 |
| M-CSF | 9668.53 ± 2019.88 | 10231.14 ± 1334.67 |
| MCP-1 | 802.98 ± 83.29 | 1060.02 ± 111.07 |
| MIG | 5875.32 ± 847.08 | 10975.98 ± 1547.85 |
| MIP-1α | 712.39 ± 79.62 | 825.76 ± 39.39 |
| MIP-1β | 394.28 ± 47.30 | 428.82 ± 27.27 |
| MIP-2 | 1805.22 ± 214.85 | 1885.70 ± 120.40 |
| RANTES | 148.36 ± 26.62 | 401.14 ± 209.15 |
| TNF-α | 200.38 ± 26.12 | 292.54 ± 33.32 |
| VEGF | 86.62 ± 19.51 | 123.15 ± 16.40 |

*P < 0.01

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

What is claimed is:

1. A method for treating or preventing an autoimmune disease in a subject, comprising administering to the subject a composition comprising a glycated α-lactalbumin, a glycated β-lactoglobulin, or a combination thereof.

2. The method of claim 1, wherein the autoimmune disease comprises type 1 diabetes or gestational diabetes.

3. The method of claim 1, wherein the method delays the onset of type 1 diabetes in the subject.

4. The method of claim 1, wherein the method reduces the incidence of type 1 diabetes in the subject.

5. The method of claim 1, wherein the autoimmune disease comprises autoimmune prostatitis.

6. The method of claim 1, wherein
the glycated α-lactalbumin has 1 to 12 glucose moieties, and
the glycated β-lactoglobulin has 1 to 16 glucose moieties.

7. The method of claim 1, wherein the glycated β-lactoglobulin comprises glycated β-lactoglobulin A, glycated β-lactoglobulin B, or a combination thereof.

8. The method of claim 1, wherein the composition comprises at least 95 wt % glycated α-lactalbumin and glycated β-lactoglobulin.

9. The method of claim 1, wherein the composition comprises glycated α-lactalbumin, wherein at least 74% of the glycated α-lactalbumin has 6 glucose moieties.

10. The method of claim 1, wherein the composition comprises glycated β-lactoglobulin, wherein at least 54% of the glycated β-lactoglobulin has 10 glucose moieties.

11. The method of claim 1, wherein the composition is produced by a process comprising dissolving a protein isolate capable of forming glycation products and glucose in water, freeze-drying the solution to produce a powder, and incubating the powder in heated dry air.

12. The method of claim 11, wherein the protein isolate comprises a whey protein isolate (WPI).

13. The method of claim 12, wherein the ratio of WPI to glucose is in a molar ratio of free amino groups and reducing ends at 1:2.

14. The method of claim 1, wherein the composition further comprises a nutraceutically acceptable excipient.

15. The method of claim 1, wherein the composition is a solid unit dose form.

16. The method of claim 15, wherein the solid unit dose form comprises an enteric coating.

17. The method of claim 15, wherein the solid unit dose form comprises tablets, beads, or granules.

18. The method of claim 1, wherein the autoimmune disease comprises type 1 diabetes, and the subject is administered a composition comprising a mixture of the glycated α-lactalbumin and the glycated β-lactoglobulin, and wherein
the glycated α-lactalbumin has 1 to 12 glucose moieties, and
the glycated β-lactoglobulin has 1 to 16 glucose moieties.

19. The method of claim 18, wherein the composition is produced by a process comprising dissolving a protein isolate capable of forming glycation products and glucose in water, freeze-drying the solution to produce a powder, and incubating the powder in heated dry air.

20. The method of claim 19, wherein the protein isolate comprises a whey protein isolate (WPI).
